(19) United States
(12) Patent Application Publication
(10) Pub. No.: US 2026/0289157 A1
(43) Pub. Date: Sep. 24, 2026

(54) SYSTEM

(71) Applicant: SoftBank Group Corp., Tokyo (JP)

(72) Inventor: Koichi OWASHI, Tokyo (JP)

(73) Assignee: SoftBank Group Corp., Tokyo (JP)

(21) Appl. No.: 19/557,195

(22) Filed: Mar. 5, 2026

(30) Foreign Application Priority Data
Mar. 19, 2025 (JP) 2025-044468

(51) Int. Cl. G06F 40/40; G06F 40/103; G06F 40/253; G06F 40/268; G06F 40/289

(52) U.S. Cl. CPC G06F 40/40; G06F 40/103; G06F 40/253; G06F 40/268; G06F 40/289

(57) ABSTRACT

A system includes a processor that is configured to provide an interface for receiving an inquiry from a user, generate a prompt for instructing a generative AI model to identify an intent of the inquiry and perform an analysis based on the prompt, and sort the inquiry into an appropriate service based on the intent identified by the generative AI model.

### CROSS-REFERENCE TO RELATED APPLICATION

This application is based on and claims priority under 35 USC 119 from Japanese Patent Application No. 2025-044468 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional inquiry handling systems in communication networks often rely on manual classification or simple rule-based mechanisms to route user inquiries to appropriate services or departments. In many cases, operators or support staff must review the content of each inquiry and decide which service is responsible, which increases workload, introduces delays, and can lead to inconsistent routing results depending on the experience and judgment of each operator. Even when automatic routing is implemented, traditional keyword-based or static rule-based engines often fail to accurately capture the user's actual intent, especially when the inquiry is written in natural language, contains ambiguous expressions, or relates to multiple services. As a result, inquiries may be misrouted, causing longer resolution times, repeated transfers between departments, and deterioration of user experience. There is a need for a system that can more accurately understand the intent of an inquiry expressed in natural language and efficiently sort and route the inquiry to an appropriate service while reducing the manual burden on operators and maintaining high scalability as the number and variety of services increase.

### SUMMARY

In order to solve the above-described problems, according to one aspect of the present invention, there is provided a system comprising a processor, wherein the processor is configured to provide an interface for receiving an inquiry from a user, generate a prompt for instructing a generative AI model to identify an intent of the inquiry and perform an analysis based on the prompt, and sort the inquiry into an appropriate service based on the intent identified by the generative AI model. In one embodiment, the processor is configured to generate a prompt for instructing the generative AI model to automatically determine a related service from contents of the inquiry and perform the analysis based on the prompt, thereby enabling the generative AI model to infer a service category directly from natural language text. In another embodiment, the processor is configured to sort the inquiry by using a predefined rule set based on a service of a communication network that received the inquiry, thereby combining AI-based intent identification with rule-based routing according to network-specific service definitions. By integrating prompt generation for the generative AI model, intent-based analysis, and service-aware rule-based sorting, the system automatically and accurately routes user inquiries to appropriate services, reduces manual classification work, shortens response time, and improves the consistency and reliability of inquiry handling across a wide range of services.

The term “system” refers to an integrated combination of hardware and software components, including at least one processor, that cooperatively perform functions for receiving, analyzing, and sorting user inquiries.

The term “processor” refers to one or more hardware processing units, such as a CPU, GPU, or dedicated processing circuitry, which execute instructions to implement the functions described in the claims, including interface control, prompt generation, AI interaction, analysis, and sorting of inquiries.

The term “interface” refers to a hardware and/or software mechanism, such as a web interface, application programming interface (API), or graphical user interface (GUI), through which a user or an external system can submit an inquiry to the system.

The term “inquiry” refers to a message, request, or question provided by a user, typically expressed in natural language text, that seeks information, support, or processing related to one or more services.

The term “user” refers to a human operator, customer, or client that submits an inquiry to the system via the interface, and for whom the system performs analysis and routing of the inquiry.

The term “generative AI model” refers to a machine learning model, such as a large language model or similar generative model, that is capable of processing natural language input and generating outputs including intent identification, classification results, and other analysis information.

The term “prompt” refers to a structured input, including instructions and possibly context, generated by the processor and provided to the generative AI model to cause the generative AI model to perform a specific analysis task, such as identifying an intent of an inquiry or determining a related service.

The term “intent” refers to a semantic representation of the purpose, goal, or underlying meaning of the user's inquiry as inferred from the contents of the inquiry by the generative AI model.

The term “analysis” refers to a processing operation in which the generative AI model interprets the inquiry based on the prompt, extracts information such as intent or related service, and outputs results used by the processor to sort or route the inquiry.

The term “service” refers to a functional unit, application, department, or business function provided in or via a communication network, such as shopping services, payment services, account management services, or customer support services, to which an inquiry can be routed.

The term “sort the inquiry” refers to assigning, routing, or categorizing the inquiry into one or more appropriate services or destinations based on the intent identified by the generative AI model or based on predefined rules.

The term “related service” refers to a service that is determined, based on the contents or intent of the inquiry, to be responsible for handling or responding to the inquiry.

The term “communication network” refers to any wired or wireless network infrastructure, such as the Internet, a mobile network, or an enterprise network, through which the user's inquiry is transmitted to the system.

The term “predefined rule set” refers to a collection of one or more rules established in advance, for example mapping conditions such as service type, network characteristics, or inquiry attributes to routing or sorting decisions, and used by the processor to sort inquiries based on a service of a communication network that received the inquiry.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

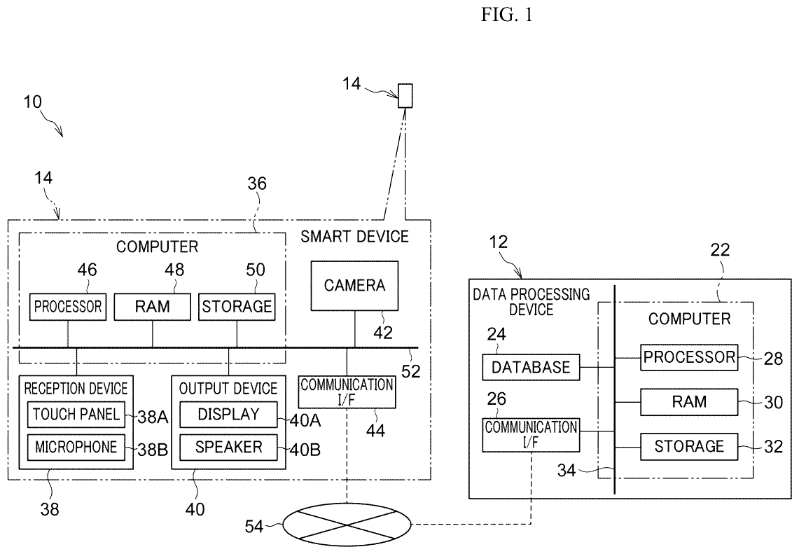

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

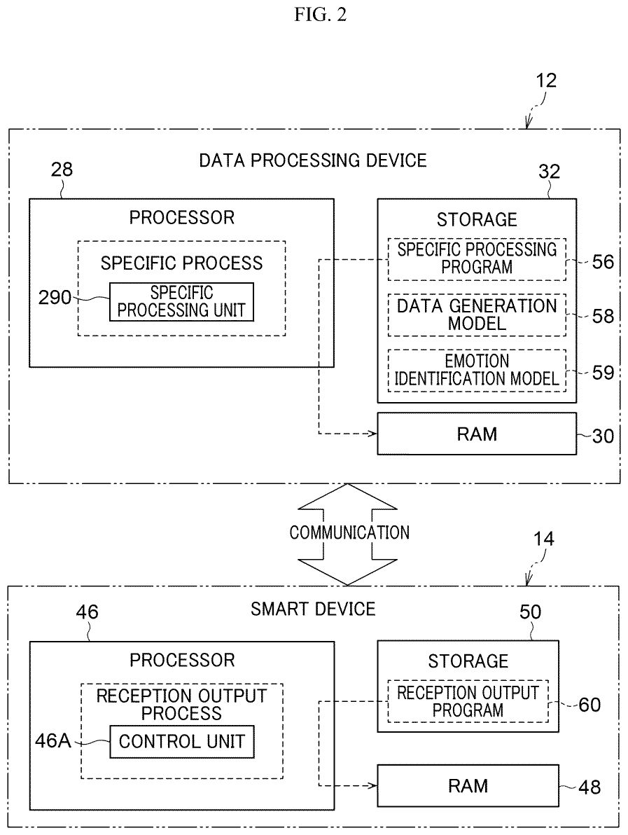

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented inquiry handling systems typically rely on static keyword matching, manually designed rule sets, or rigid decision trees to route user inquiries to backend business functions. Such systems suffer from several technical limitations when implemented at scale on general-purpose computing hardware. First, the accuracy of intent identification and service categorization degrades significantly when the user inquiry is written in natural language that includes ambiguity, colloquial expressions, or mixed topics. This leads to frequent misrouting of requests, which in turn causes additional processing, manual intervention, and increased load on computing resources. Second, when the rule sets or keyword lists are expanded in an ad hoc manner to cope with new services or products, the decision logic becomes complex and difficult to maintain, thereby increasing processing latency and memory usage due to inefficient evaluation paths. Third, conventional systems generally do not exploit the full capabilities of generative artificial intelligence models, instead using them only to generate natural language responses, without structurally integrating model outputs into the system's internal control flow for routing and execution of business logic.

From a computer-technology standpoint, these limitations manifest as suboptimal utilization of processing resources in the server, unnecessary network round-trips caused by incorrect routing and subsequent re-routing, and increased storage and logging overhead due to repeated processing of the same inquiry. The absence of a structured, model-driven classification layer between raw inquiry text and backend services prevents the server from achieving stable, predictable behavior in the presence of highly variable natural language input. Moreover, existing systems do not define, at the processor level, how a prompt sentence should be engineered and how structured outputs from a generative AI model should be used as control signals for selecting internal processing modules, leading to implementation patterns that are ad hoc and not optimized for efficient execution on a processor configured with conventional interfaces, databases, and communication stacks. Accordingly, there is a need for an improved computer-implemented system that configures a processor to (i) systematically generate a prompt sentence designed to elicit structured analysis results from a generative AI model, (ii) receive and process such structured analysis results in the form of feature information and service category information, and (iii) use these results as explicit control parameters for classifying inquiries and invoking appropriate business processing functions. By doing so, the system can improve the technical performance of the inquiry-handling pipeline, including more accurate routing on the first attempt, reduction of redundant processing, more efficient use of storage by associating raw and analyzed data in a unified schema, and improved scalability and maintainability of the routing logic as the number of services and inquiry types grows.

The specific processing by the specific processing unit 290 of the data processing device 12 in Example 1 is realized by the following means.

The present invention provides a server comprising a processor configured to provide, via a communication network, an interface for receiving inquiry information from a user and to record the inquiry information together with associated attribute information in a storage device; to generate analysis request information including analysis target information comprising the inquiry information and a prompt sentence that instructs a generative information processing model to extract important features from the analysis target information and to identify a user intent and a related service category, and to transmit the analysis request information to the generative information processing model over an application programming interface; to receive, from the generative information processing model, response information as analysis result information generated on the basis of the prompt sentence, the response information including important feature information and service category information relating to the inquiry information, and to classify, by executing classification logic, the inquiry information into a predetermined business function on the basis of the service category information and previously stored correspondence information that defines a mapping between service categories and internal processing functions; to activate, in response to the classification, a business processing function corresponding to a classification result, to obtain processing result information from the business processing function, to generate user response information based on the processing result information, and to transmit the user response information to a terminal device via the interface; and to store, in the storage device, the inquiry information, the analysis result information, and the classification result in association with one another as structured records. This enables the server to use the generative information processing model as a structured analysis engine that converts free-form natural language inquiries into explicit service category information and feature information, thereby improving the technical performance of the inquiry routing mechanism, reducing misclassification-related processing overhead, and enhancing the efficiency and scalability of computer resources involved in handling large volumes of heterogeneous user inquiries.

The term “inquiry information” refers to electronic data representing a user's question, request, or message, expressed in natural language and received by the system via a communication interface.

The term “attribute information” refers to additional electronic data associated with inquiry information, including but not limited to user identifiers, communication channel types, timestamps, and network identifiers.

The term “analysis target information” refers to electronic data that includes at least the inquiry information and is used as input for analysis by a generative information processing model.

The term “prompt sentence” refers to electronic instruction data, expressed in natural language or a structured format, that specifies to a generative information processing model how to analyze the analysis target information and what type of output to produce.

The term “analysis request information” refers to electronic data transmitted to a generative information processing model, including at least the analysis target information and the prompt sentence.

The term “generative information processing model” refers to a machine-implemented model, such as a generative artificial intelligence model, configured to process input data according to a prompt sentence and to generate output data including analysis or classification results.

The term “response information” refers to electronic data output from a generative information processing model in response to analysis request information.

The term “analysis result information” refers to electronic data contained in the response information, including at least important feature information and service category information derived from the inquiry information.

The term “important feature information” refers to electronic data representing extracted characteristics of the inquiry information, including but not limited to keywords, phrases, intents, or entities that are relevant to classifying or handling the inquiry.

The term “service category information” refers to electronic data indicating a classification label or category that represents a type of service or function deemed relevant to the inquiry information.

The term “correspondence information” refers to electronic mapping data that defines relationships between service category information and one or more internal processing functions or business processing functions.

The term “business function” refers to a logical operation or processing role executed by the system to handle an inquiry, such as processing returns, checking order status, or providing technical support.

The term “classification result” refers to electronic data indicating the outcome of assigning inquiry information to a particular business function or service category based on service category information and correspondence information.

The term “business processing function” refers to a software-implemented functional module or service that performs one or more business operations in response to the classification result, and that outputs processing result information.

The term “processing result information” refers to electronic data generated by a business processing function, representing outcomes of business operations performed in response to the inquiry information.

The term “user response information” refers to electronic data formatted for delivery to a user, derived at least in part from processing result information, and intended to answer or address the user's inquiry.

The term “terminal device” refers to an electronic device operated by a user, such as a computing device, a mobile communication device, or another network-capable device, that is configured to send inquiry information to and receive user response information from the server.

The term “storage device” refers to a hardware or virtualized component, such as a memory device or database system, configured to store electronic data including inquiry information, analysis result information, and classification results.

The term “structured data format” refers to a machine-readable format in which data elements are arranged according to a predefined schema, such as a format based on key-value pairs, arrays, or objects, including but not limited to a JSON-like structure.

The term “predefined rule set” refers to electronic data defining one or more rules or conditions used by the processor to select an internal processing function or business processing function based on service category information and additional factors such as channel type, user attributes, or time of occurrence.

The term “internal processing function” refers to a software-implemented processing module within the system or within a related backend subsystem that performs computation or data manipulation in response to control information, including classification results.

In one embodiment, a server implements the claimed system by executing one or more software modules on general-purpose computing hardware. The server includes at least one central processing unit (CPU), a main memory device, a non-volatile storage device, a network interface controller, and optionally a hardware accelerator such as a graphics processing unit (GPU). The server runs an operating system such as a generic server operating system, and an application stack that may include a web server component, an application framework, and a database management component such as a relational database or a document-oriented database.

The server provides, via a communication network, an interface through which a user operates a terminal to input inquiry information. The terminal runs a web browser or a mail client application and communicates with the server using a transport protocol such as HTTP, HTTPS, or SMTP over TCP/IP. The server executes a web application framework, for example a representative scripting framework, a representative object-oriented framework, or a representative lightweight framework, in combination with a front-end web server such as a generic HTTP server. The server exposes an endpoint that receives inquiry information in the form of natural-language text supplied by the user. The server parses an incoming request, decodes the request body into a character encoding such as UTF-8, and stores the resulting inquiry information together with attribute information such as a user identifier, a channel type, a timestamp, and a source network address in a storage device managed by a database engine such as a conventional relational database engine or a conventional document database engine.

The server generates analysis request information that bundles the inquiry information with a prompt sentence. The server constructs the prompt sentence in application logic as a text string that explicitly instructs a generative AI model to perform feature extraction and service categorization and to output a result in a structured form. In one example, the server generates a prompt sentence such as: “Analyze the following user inquiry text, extract at least two important keywords, infer the user's intent in one sentence, and choose the most appropriate service among {‘Return Service’, ‘Order Status Service’, ‘Technical Support’, ‘Account Management’}. Respond in valid structured text with three fields named ‘keywords’, ‘intent’, and ‘service_category’. User inquiry: ‘Please tell me how to return a product.’”

In another example, the server generates a prompt sentence such as: “Analyze the following user inquiry and determine which internal service category should handle it. First, list the key terms you used, then provide the inferred intent in one sentence, and finally output a single service category name from the following set: {‘Return Service’, ‘Order Status Service’, ‘Technical Support’, ‘Account Management’}. User inquiry: ‘I want to know the procedure for returning an item I purchased.’”

The server concatenates the prompt sentence with the inquiry information or embeds the inquiry information into a template that surrounds the user text with explicit instructions and field names. The server encapsulates the combined data as analysis request information in a data structure such as a key-value object or a serialized textual format and transmits this information to a generative AI model via an application programming interface (API) using an HTTP client library. The server includes authentication data such as an API key or a token in the request header.

In one embodiment, the generative AI model resides on a separate computing system connected over the network. The generative AI model is realized as a neural network having a transformer architecture. The model includes an embedding layer that maps tokens to high-dimensional vectors, a plurality of self-attention layers, feed-forward layers, and normalization layers. The model processes a token sequence that represents the prompt sentence and the inquiry information. The model computes attention scores across tokens to capture long-range dependencies and semantic relations within the natural-language input. The model has been trained in advance on a large corpus of natural-language data using a supervised or semi-supervised learning method. During training, the model receives sequences of tokens and target sequences and minimizes a loss function such as cross-entropy loss. The training procedure updates weight parameters of the network using an optimization algorithm such as stochastic gradient descent or a variant such as Adam. In some embodiments, the model has been fine-tuned on domain-specific inquiry-category pairs stored in a training dataset, and the server or an offline training system applies techniques such as data augmentation, where semantically similar inquiries are generated by paraphrasing or by modifying non-critical tokens, to increase robustness.

The generative AI model, in response to analysis request information, generates response information that includes analysis result information encoded as text. The response information contains important feature information such as keyword strings derived from the inquiry information and service category information selected from among predetermined category labels. The generative AI model follows constraints described in the prompt sentence, which specify output fields and formats. For example, the response information may contain text of the form:
“keywords: [‘return’, ‘product’]
intent: ask how to return a purchased product
service_category: Return Service”

The server receives the response information from the generative AI model via the API. The server parses the textual response and extracts the analysis result information according to the output constraints specified in the prompt sentence. The server, for example, identifies lines beginning with “keywords:”, “intent:”, and “service_category:” and converts these values into internal data structures such as arrays or string variables. The server validates the extracted values by checking that the service category corresponds to one of a set of permissible categories stored in configuration data. The server then accesses correspondence information stored in the storage device that defines a mapping between service category labels and internal processing functions or modules. The server identifies a business processing function that should handle the inquiry information based on the service category information and the correspondence information.

The server activates the identified business processing function, which may be implemented as a local module, a microservice accessed via an internal network protocol, or a library function that queries domain-specific data. The server passes to the business processing function parameters such as the inquiry information, the user identifier, and the service category. The business processing function retrieves or computes processing result information, for example step-by-step instructions for product returns, order tracking data, or troubleshooting guidance, by performing data retrieval and arithmetic operations over records stored in the database. The business processing function may perform operations such as filtering records by user identifier, joining tables that represent orders and products, and formatting structured data into intermediate representations.

The server generates user response information using the processing result information. The server may employ a template engine to merge structured values into response message templates. The server then transmits the user response information to the terminal via the same interface used to receive the inquiry information. For a web-based interface, the server returns an HTTP response containing the response text or a markup document. For an email-based interface, the server composes an outgoing message using an email protocol library and sends it to a mail transfer agent. The terminal receives the user response information and displays it to the user on a display device. The user can then perform actions in the physical world, such as packing a product and printing a label, based on the server's instructions.

The server further stores, in the storage device, a record that links the original inquiry information, the analysis result information, and the classification result. The record may also include system-level metrics such as processing latency, model version, and communication channel information. By maintaining this structured association, the server enables later auditing, performance analysis, and retraining data collection.

This configuration yields technical effects beyond mere automation of human workflows. The system uses the generative AI model as a structured analysis engine, not simply as a natural-language response generator. The prompt sentence specifies a non-conventional interaction pattern: the model is instructed to emit explicit control parameters (keywords, intent, and service category) that the server uses for routing within a modular architecture. Because the transformer-based model can capture long-range dependencies and semantic nuances that simple keyword matching cannot, the service category information is more accurate and robust to linguistic variation. As a result, the server reduces the number of misrouted inquiries and the need for repeated queries to backend modules. This reduction leads to lower CPU usage, reduced memory footprint due to fewer duplicated records, and lower network traffic between the server and backend services. The system thus improves processing speed and scalability when deployed on multi-core processors and distributed computing infrastructures.

The server also improves data management by storing unified records that combine raw and analyzed data. This structure simplifies index design in the database and allows efficient querying for analytics and monitoring. For example, the server can create composite indexes on user identifier and service category, enabling fast retrieval of all inquiries in a given category. Because the classification is performed in a single pass using the generative AI model outputs, the server does not need to run multiple rule-based classifiers sequentially, which would otherwise increase computation time and complexity.

From the viewpoint of computer technology, the use of prompt sentences that enforce structured output also reduces parsing errors and exception handling overhead. The server no longer needs to apply complex pattern-matching heuristics to free-form responses, because the model is constrained to output fields and values in a predictable format. This constraint is enforced at the model level via training and at the inference level via the prompt design. The server therefore executes simpler parsing routines, which require fewer CPU cycles and less transient memory allocation in the runtime environment.

In some embodiments, the server maintains multiple prompt sentence variants and selects among them at runtime based on attribute information such as language, channel type, or user segment. For example, the server may choose a more detailed prompt for email inquiries that tend to be long and multi-topic, and a more concise prompt for short chat-based inquiries. This adaptive prompt selection reduces the size of the input sequence passed to the generative AI model without degrading classification quality, thereby reducing computational load on the model host and improving response time.

In another embodiment, the server maintains more than one generative AI model. One model is specialized in keyword extraction, and another is specialized in service categorization. The server constructs different prompt sentences for each model, such as:

“For the following text, output only a list of important keywords that represent the main topics of the inquiry. Do not output any explanatory sentences. User inquiry: ‘Please tell me how to return a product I purchased last week.’” and

“Based on the following list of keywords and the original inquiry, determine the single best service category from {‘Return Service’, ‘Order Status Service’, ‘Technical Support’, ‘Account Management’} and output only the category name.”

The server uses the output of the first model as part of the input to the second model or as additional features for its own internal rule-based classifier. This modular design further improves accuracy and allows the server to allocate computing resources in a flexible manner, for example by running the smaller keyword extraction model on a local processor and delegating the more complex categorization task to a remote accelerator-equipped host.

The training process of the generative AI model, as implemented by a training system or by the server itself in an offline mode, includes the following technical elements: the model receives labeled examples consisting of user inquiry text and target service category labels; a tokenization algorithm converts each text into a sequence of token identifiers; the model generates predicted token sequences representing structured outputs; a loss function such as cross-entropy between predicted and target tokens is computed; and weights are updated using backpropagation and an optimizer. In some variants, the training system applies curriculum learning, where shorter and simpler inquiries are used in early training stages and longer, multi-sentence inquiries with overlapping topics are introduced later. This training regime yields improved generalization and reduces error rates for complex inputs. Because the model learns to output structured labels directly, the server can omit intermediate feature engineering steps that would otherwise consume CPU resources and memory.

The server employs a non-conventional rule set at the classification layer. Instead of relying solely on static keyword-to-service mappings, the server uses the service category information generated by the model as the primary routing signal and uses the rule set only as a secondary filter that takes into account attribute information such as channel type and time.

For example, if the model outputs “Return Service” but the inquiry originates from a channel reserved for technical issues during a maintenance window, the rule set can override or refine the classification to a “Technical Support” module specific to maintenance operations. This layered scheme reduces the complexity of the rule set and leverages the strengths of both learned semantic classification and deterministic constraints. The result is a more stable and predictable system behavior under varying traffic conditions and evolving service portfolios.

The terminal and the user interact with the system in a conventional manner. The user enters natural-language text in a form or message interface on the terminal. The terminal transmits this text to the server and displays the server's response. Neither the terminal nor the user is required to understand the internal data structures or the classification logic. The technical improvements are realized in the server's internal handling of data, its interaction with the generative AI model, and its management of storage and processing resources.

By configuring the server in the manner described, the system implements a specific, structured flow of data and control that improves the underlying computer technology involved in handling large volumes of heterogeneous natural-language inquiries. The server reduces misclassification, network overhead, and resource consumption while increasing throughput and reliability. These improvements arise from the combination of engineered prompt sentences, transformer-based generative AI models, structured analysis result information, and rule-based routing logic that collectively optimize how the processor manages inquiry data, model interactions, and business processing functions.

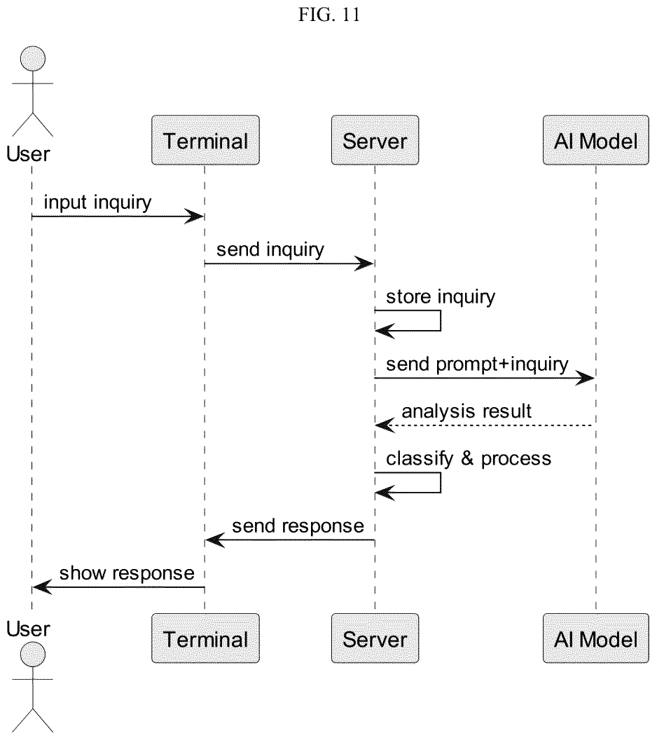

The following describes the processing flow using FIG. 11.

### Step 1

The user operates the terminal to create inquiry information.

The user opens an application on the terminal, such as a web browser or an email client, and inputs an inquiry in natural language, for example, “Please tell me how to return a product I purchased.”

The terminal receives keystroke events from an input device, constructs a text string from those events, and displays the text in an input field.

Input: raw user keystrokes and control events.

Output: a completed inquiry text string held in the terminal's application memory.

### Step 2

The terminal transmits the inquiry information to the server.

The terminal embeds the inquiry text into a request message, for example an HTTP POST body or an email message body, and adds protocol headers such as destination address, content type, and encoding (e.g., UTF-8).

The terminal passes the composed message to the operating system's network stack, which segments the data and sends it over a communication network using TCP/IP.

Input: inquiry text string and session metadata within the terminal.

Output: a network packet stream containing the inquiry information and basic metadata sent toward the server.

### Step 3

The server receives and parses the inquiry information.

The server's network interface receives the packet stream, reconstructs the request message, and forwards it to a web server or mail server process.

The server parses protocol headers, extracts the message body, decodes the character encoding, and stores the inquiry text in a string variable.

The server also derives attribute information such as timestamp, source IP address, channel type, and any available user identifier.

Input: protocol-level request message containing the inquiry text.

Output: an internal data object including inquiry information (text) and attribute information (metadata).

### Step 4

The server stores the inquiry information and attribute information in a storage device.

The server establishes a connection to a database engine and executes an insertion operation, creating a record with fields such as inquiry_id, user_id, channel_type, inquiry_text, and created_at.

The server generates a unique identifier for the inquiry (e.g., by incrementing a sequence or computing a UUID) and associates this identifier with the stored record.

Input: internal data object with inquiry text and attribute information.

Output: a persistent database record identified by inquiry_id and a confirmation status indicating successful storage.

### Step 5

The server constructs a prompt sentence for the generative AI model.

The server selects a prompt template according to the channel type or language and fills placeholder positions with instructions and field names.

The server, for example, generates the following prompt sentence: “Analyze the following user inquiry text, extract at least two important keywords, infer the user's intent in one sentence, and choose the most appropriate service among {‘Return Service’, ‘Order Status Service’, ‘Technical Support’, ‘Account Management’}. Respond in valid structured text with three fields named ‘keywords’, ‘intent’, and ‘service_category’. User inquiry: ‘[inquiry_text]’.”

The server inserts the actual inquiry_text into the placeholder.

Input: inquiry text string and configuration parameters such as available service categories.

Output: a completed prompt sentence string ready to be sent to the generative AI model.

### Step 6

The server generates analysis request information and transmits it to the generative AI model.

The server builds a request structure including the prompt sentence, model identifier, and optional parameters such as maximum output length and temperature.

The server serializes this structure into a text-based format and sends it via an HTTP POST request to the API endpoint that fronts the generative AI model.

The server adds authentication information in the header and logs the inquiry_id and model identifier for traceability.

Input: prompt sentence string and model configuration data.

Output: an outbound API request message containing analysis request information transmitted to the generative AI model.

### Step 7

The generative AI model processes the prompt sentence and inquiry information.

The generative AI model tokenizes the input text into discrete tokens, transforms each token into a vector embedding, and forwards the token sequence through multiple transformer layers composed of self-attention blocks and feed-forward networks.

The generative AI model computes context-aware representations of each token position and decodes these representations into output tokens that form a textual answer, following the constraints described in the prompt sentence.

Input: serialized prompt sentence and associated model parameters.

Output: a generated text response that includes analysis result information such as keywords, intent, and service category.

### Step 8

The server receives and parses the response information from the generative AI model.

The server reads the HTTP response, checks the status code, and extracts the response body as a text string.

The server scans the response text to locate lines or segments corresponding to “keywords”, “intent”, and “service_category”, and converts these segments into internal data types such as an array of keyword strings and single strings for intent and service category.

Input: textual response from the generative AI model.

Output: an internal analysis result object containing important feature information and service category information.

### Step 9

The server determines a classification result based on the analysis result information.

The server loads correspondence information from configuration data or from the database, where each service category label is mapped to one or more internal business processing functions.

The server compares the service_category string obtained from the analysis result with the keys in the correspondence information and selects a matching business processing function identifier.

If multiple matches exist, the server applies deterministic rules that consider attribute information such as channel_type or time of day to choose a single function.

Input: analysis result object (keywords, intent, service_category) and correspondence information.

Output: a classification result including the selected business processing function identifier and an updated status for the inquiry.

### Step 10

The server invokes a business processing function according to the classification result.

The server dispatches a call to the selected business processing function, passing arguments such as inquiry_id, inquiry_text, user_id, and service_category.

The business processing function may query domain-specific tables in the database, perform logical decisions based on policy rules, and assemble processing result information, for example a list of procedural steps or a link to a help resource.

Input: classification result and original inquiry-related data.

Output: processing result information produced by the business processing function.

### Step 11

The server generates user response information from the processing result information.

The server selects a response template corresponding to the service_category and inserts dynamic elements such as instructions, links, or identifiers into placeholder positions in the template.

The server creates a final response message text that explains to the user how to proceed, for example, how to return a product or how to check order status.

Input: processing result information and a response template definition.

Output: a formatted user response message text.

### Step 12

The server transmits the user response information to the terminal.

The server encapsulates the response message text into an HTTP response for web channels or into an email message for mail channels, adding appropriate headers such as content type and subject.

The server sends the message through the network stack to the terminal's address and updates the inquiry record in the database with a reference to the sent response and a status such as “answered”.

Input: user response message text and session or address information.

Output: a network message containing the user response information delivered toward the terminal.

### Step 13

The terminal receives and presents the user response information to the user.

The terminal's communication stack receives the network message, reconstructs the HTTP response or email message, and passes the content to the web browser or mail client.

The terminal renders the text on a display device, optionally with formatting or interactive elements such as links or buttons.

Input: network-level response message from the server.

Output: a human-readable presentation of the response on the terminal, enabling the user to view and act on the instructions.

### Step 14

The server records the linkage between the inquiry, the analysis result, and the classification result.

The server updates the database record associated with inquiry_id to include fields for keywords, intent, service_category, selected business processing function, model identifier, and processing timestamps.

The server writes these fields using an update operation and may create or update indexes to allow efficient retrieval by service_category or model version.

Input: analysis result object, classification result, and existing database record.

Output: a consolidated, persistent record that associates the original inquiry information, the generative AI model's analysis, and the server's routing decision.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional question-answering and routing systems on computer networks typically rely on manually designed rule sets, keyword lists, or fixed intent classifiers to determine how to process user inquiries. In such systems, a processor often matches an incoming text query against predefined patterns or invokes a static classification model that was trained on limited categories. As a result, the system tends to exhibit several technical deficiencies at the computing level.

First, when the system receives natural language text that deviates from expected phrasing or contains ambiguous expressions, the processor may fail to correctly identify the user's intent.

This leads to inaccurate routing of the inquiry to backend services, causing unnecessary processing by inappropriate components, redundant database accesses, and increased network traffic between services. Consequently, the overall efficiency of resource utilization in the computing environment is degraded.

Second, because the routing logic is typically hard-coded or tightly coupled to a particular classification model, updating the logic to support new inquiry types requires extensive reconfiguration or redeployment of software modules. This rigidity increases the computational overhead associated with maintaining the system, and it hinders dynamic adaptation of the processor's behavior at runtime based on actual traffic patterns and content characteristics.

Third, conventional systems generally do not exploit the expressive capabilities of generative artificial intelligence models as a part of the core routing mechanism. Even when a generative model is used, it is often invoked only to generate human-readable responses, while the low-level decision of how to route the inquiry is still made by a separate, brittle classification mechanism. As a result, the processor does not fully leverage the powerful contextual understanding of the generative model to refine internal control flow, and therefore the computation performed by the processor remains sub-optimal.

Fourth, the formatting of response information is frequently handled as a simple, fixed template-based process. The processor may output text with a constant detail level, structure, or length regardless of the type or classification of the inquiry. This can increase the amount of data transmitted over the network and processed by user terminals, and can also force the terminal to perform additional processing to adapt the response to the user's context, thereby consuming extra computational resources at the terminal side.

Accordingly, there is a need for an improved computer-implemented system in which a processor performs text analysis, prompt construction, interaction with a generative artificial intelligence model, and dynamic output control in an integrated manner. Such a system should enhance the accuracy and robustness of inquiry routing and response generation, reduce wasted computation caused by mis-routed queries and overlong responses, and allow the routing and formatting behavior to be adaptively adjusted at runtime based on the content of the inquiry. By restructuring these operations around a coordinated use of natural language processing and prompt-based interaction with a generative artificial intelligence model, it becomes possible to improve the operation of the computer itself, in terms of processing efficiency, adaptability, and resource utilization, rather than merely automating a human workflow.

The specific processing by the specific processing unit 290 of the data processing device 12 in Application Example 1 is realized by the following means.

The present invention provides a server comprising a processor configured to receive inquiry information transmitted from a user terminal via a communication network and acquire the inquiry information as character information, execute morphological analysis and syntactic analysis on the acquired character information by using a natural language processing program implemented as language analysis software to extract keywords and phrases from the character information, construct a prompt sentence to be input to a generative artificial intelligence model on the basis of the extracted keywords and phrases and a type of the inquiry, transmit the prompt sentence to the generative artificial intelligence model, acquire response information generated by the generative artificial intelligence model in response to the prompt sentence, perform formatting processing on the response information into a predetermined output format, and transmit the formatted response information toward the user terminal so that the user terminal outputs the formatted response information in a visually or auditorily presentable form. This enables the processor to improve internal control of text routing and response generation by using the results of natural language analysis to construct prompt sentences that guide a generative artificial intelligence model, thereby increasing the accuracy of intent determination and service selection, reducing unnecessary computation and data transfer associated with mis-routed inquiries and poorly structured responses, and dynamically adapting the level of detail, length, and structure of the output according to the classification of the inquiry, which in turn improves the efficiency and robustness of the overall computer system.

The term “processor” refers to a hardware execution unit, such as a central processing unit or a processing core, and associated control logic configured to execute instructions of a program to perform information processing operations described in this specification.

The term “user terminal” refers to an information processing apparatus operated by a user, such as a computing device including an input interface, an output interface, and a communication interface, and configured to transmit inquiry information to a server and to present response information to the user.

The term “communication network” refers to a wired or wireless data transmission infrastructure, including at least one of a local area network, a wide area network, or a global network, through which digital data is exchanged between a user terminal and a server.

The term “inquiry information” refers to digital data representing a user's question, request, or instruction, typically expressed as natural language text, that is transmitted from a user terminal to a server for processing.

The term “character information” refers to data representing a sequence of textual symbols, including letters, numerals, punctuation marks, and control characters, encoded in a character encoding scheme and corresponding to at least part of inquiry information.

The term “natural language processing program” refers to software implemented as executable instructions that cause a processor to perform language analysis on character information, including at least one of tokenization, morphological analysis, syntactic analysis, semantic analysis, or entity recognition.

The term “language analysis software” refers to a class of natural language processing programs that apply statistical methods, rule-based methods, or machine learning methods to analyze natural language text and to output structured information about the text.

The term “morphological analysis” refers to a processing operation in which character information is segmented into minimal linguistic units such as words or morphemes, and in which attributes such as part of speech or base form are assigned to the segmented units.

The term “syntactic analysis” refers to a processing operation in which grammatical relationships among linguistic units in character information are determined, including at least one of phrase structure, dependency relations, or clause boundaries.

The term “keywords” refers to linguistic units extracted from character information that are determined to be highly relevant to the subject, intent, or category of an inquiry, and that are used to guide subsequent processing such as prompt construction.

The term “phrases” refers to groups of one or more tokens in character information that function as syntactic or semantic units, including at least noun phrases, verb phrases, or prepositional phrases, and that may be extracted for use in analysis or prompt construction.

The term “type of the inquiry” refers to a classification category assigned to inquiry information, indicating a functional or semantic class such as a request type, topic type, or service type, determined on the basis of language analysis or predefined rules.

The term “prompt sentence” refers to a sequence of characters forming a natural language instruction or context description that is constructed by a processor and provided as input to a generative artificial intelligence model to control or guide the model's generation behavior.

The term “generative artificial intelligence model” refers to a parameterized computational model, such as a neural network configured for language modeling, that generates output data including at least natural language text in response to input data such as a prompt sentence.

The term “response information” refers to data generated by a generative artificial intelligence model based on a prompt sentence, including at least textual content representing an answer, explanation, or guidance related to inquiry information.

The term “formatting processing” refers to a transformation operation applied to response information in which at least one of layout, structure, style, segmentation, or length of the response information is modified to conform to a predetermined output format or presentation rule.

The term “predetermined output format” refers to a specification of how response information is to be arranged and represented for output, including at least one of a markup format, a structured data format, a paragraph structure, or a list structure.

The term “visually or auditorily presentable form” refers to a representation of response information that can be output through at least one of a display device as visual information or a sound output device as audio information, such that a user can perceive the content.

The term “statistical method” refers to a computational technique that processes data by applying probabilistic models, frequency-based analysis, or other statistical inference methods to estimate properties or structures of natural language text.

The term “machine learning method” refers to a computational technique in which a model is trained from example data to learn parameters or rules, and in which the trained model is used by a processor to perform tasks such as text classification, intent estimation, or entity recognition.

The term “intention of the inquiry” refers to a semantic target or goal inferred from inquiry information, indicating what operation, information, or service the user is seeking, as determined by analysis of the content of the inquiry.

The term “classification of the inquiry” refers to a label or set of labels assigned to inquiry information by a processor, indicating membership in one or more predefined categories used to control routing, prompt construction, or output formatting.

The term “dynamic change” refers to a modification of a processing parameter, content, or format performed during runtime by a processor in response to analysis results, without requiring manual reconfiguration or redeployment of software.

The term “output control processing” refers to a set of operations executed by a processor to adjust properties of response information, including at least detail level, text length, structural components, or linked reference information, based on one or more control criteria.

The term “predefined rule set” refers to a collection of conditions and associated actions, stored in a memory and interpreted by a processor, that specify how response information is to be adjusted or routed based on attributes of an inquiry or its classification.

The term “detail level of explanation” refers to a measure of how granular or comprehensive the content of response information is, including for example whether the response provides high-level summaries or step-by-step procedures.

The term “structural components” refers to logical segments of response information, including at least headings, paragraphs, bullet points, numbered lists, or sections, that define the organization of the output text.

The term “reference destination information” refers to data specifying at least one external or internal resource associated with response information, such as identifiers, addresses, or links that indicate where additional or related information is located.

In one embodiment, a server, a terminal, and a user cooperate to implement a system that generates, routes, and outputs responses to natural language inquiries by constructing and using a prompt sentence for a generative AI model. The system is realized as a combination of hardware components and software components executed by a processor in the server and processors in the terminals.

A server includes at least one processor, a main memory, a non-volatile storage device, and a network interface. The server runs an operating system and application software including a web server, an application framework, a natural language processing program, and a generative AI model client library. The server may be implemented as a physical machine or as a virtual machine in a data center. A terminal includes at least one processor, a memory, a display, an input device such as a keyboard or a touch panel, an audio output device such as a speaker, and a communication module such as a wireless communication interface. The terminal runs a browser or a native application that communicates with the server. A user operates the terminal to submit inquiries and to receive responses.

The server uses specific software to implement the claimed functions. For example, the server executes a web server program such as a hypertext transfer protocol server, and an application server based on a scripting language runtime and a web framework. The server uses a natural language processing library such as a language analysis software including a tokenizer, a morphological analyzer, and a syntactic parser; as one concrete example, the server may use a library of the class of spaCy. The server uses a generative AI model provided as a service, for example a large language model of the class of GPT models, via a remote application programming interface. The generative AI model internally uses a neural network such as a transformer architecture including an embedding layer, multiple self-attention layers, feed-forward layers, and a decoder, trained using gradient-based optimization on large corpora of text data.

The server acquires inquiry information as character information. The terminal sends the inquiry information as a sequence of characters representing a natural language sentence, encoded in a character encoding scheme, through the communication network. The server stores the received character information in a memory buffer and normalizes the character information by standardizing white spaces, control characters, and encoding. The server thereby provides a stable input to the natural language processing program, reducing parsing errors and improving consistency of downstream processing.

The server executes morphological analysis and syntactic analysis on the normalized character information using the natural language processing program. The natural language processing program segments the character information into units such as tokens, assigns part-of-speech tags to each token, and determines dependency relations among tokens. The server obtains a data structure representing the analyzed text, for example a tree or a graph where nodes correspond to tokens and edges correspond to syntactic relations. The server then applies extraction rules to the data structure to identify keywords and phrases. In one example, the server extracts all noun phrases and verb phrases that satisfy specific patterns of parts of speech and dependency relations, and assigns a relevance score to each phrase based on token frequencies, syntactic roles, or position in the sentence. The server selects phrases whose relevance scores exceed a threshold as keywords and phrases.

The server uses the extracted keywords and phrases, together with a type of the inquiry, to construct a prompt sentence. The server determines the type of the inquiry by applying a classification algorithm to features derived from the analyzed text. The classification algorithm may be implemented as a machine learning model such as a logistic regression classifier, a support vector machine, or a small neural network, which takes as input feature vectors generated from token counts, phrase embeddings, or intent labels and outputs an inquiry classification label such as “return request”, “shipping status”, or “product specification”. The server stores a mapping from classification labels to prompt templates.

Each prompt template is a natural language sentence or group of sentences that instructs the generative AI model how to interpret the inquiry and what style of response to produce.

The server constructs a prompt sentence by inserting the extracted keywords and phrases and the original inquiry text into the selected prompt template. For example, when the user sends an inquiry such as:

“Please tell me how to return a product I recently purchased.” the server may construct the following prompt sentence:

A customer says: “Please tell me how to return a product I recently purchased.”

The customer wants to know the return method.

Based on a typical e-commerce return policy, explain the return procedure step by step in clear and concise English.

In another example, when the user sends an inquiry such as:

“Where is my order now?” the server may construct the following prompt sentence:

A customer asks: “Where is my order now?”

The customer wants to understand the typical shipping status flow in an online store.

Explain how a user can check the shipping status of an order and what each status such as “processing”, “shipped”, and “out for delivery” usually means.

In yet another example, when the user sends an inquiry such as:

“Is this laptop suitable for video editing?” the server may construct the following prompt sentence:

A customer asks: “Is this laptop suitable for video editing?”

Without knowing the exact model, explain what hardware specifications (CPU, GPU, RAM, and storage) are generally recommended for video editing.

Provide guidance on how to judge whether a laptop is suitable based on those specifications.

The server transmits the constructed prompt sentence to the generative AI model via a network connection. The server uses a client library to send the prompt sentence as input to the generative AI model, specifying a model identifier, a maximum number of output tokens, a sampling temperature, and other parameters. The generative AI model executes a sequence of operations including tokenization of the prompt sentence, embedding of tokens into vectors, repeated application of attention mechanisms and feed-forward transformations layer by layer, and generation of probability distributions over possible next tokens. The generative AI model then selects and outputs a sequence of tokens representing response information.

The model is trained in advance using supervised learning and unsupervised learning; for example, the model parameters are updated by a gradient descent algorithm minimizing a loss function such as cross-entropy between predicted token distributions and actual tokens in training data. During training, the model may also be refined using data augmentation techniques such as random masking of words, shuffling within constrained windows, and synonym replacement.

The server acquires the generated response information and performs formatting processing on the response information. The server parses the output tokens into sentences and paragraphs, and adjusts the detail level, text length, and structural components based on the classification of the inquiry and a predefined rule set. The predefined rule set may specify, for example, that a “return request” inquiry requires a step-by-step numbered list with short sentences, while a “product specification” inquiry requires a table-like structure and a summary paragraph. When the generated response is longer than a configured maximum, the server truncates less important sentences or compresses information by merging overlapping sentences. The server may also insert internal links or identifiers that can be used by other modules or devices to query additional information, thereby reducing repeated computations for subsequent related requests.

The server then transmits the formatted response information to the terminal. The terminal receives the response information and displays it on the screen using a user interface that may resemble a chat interface or a structured answer panel. The terminal can also convert the text into speech using a local text-to-speech engine and output the speech through its speaker. The user reads or listens to the response and may then input further inquiries that the server will process using the same architecture.

This architecture provides specific improvements to computer technology beyond automation of a human task. The server reduces computational overhead by using morphological and syntactic analysis to construct more efficient prompt sentences. Because the prompt sentence explicitly includes extracted keywords, classification labels, and context, the generative AI model can generate more precise responses in fewer tokens, which reduces the number of network round trips and the volume of data transmitted between the server and the generative AI model. The server further controls the length and structure of response information before sending it to the terminal, reducing bandwidth usage and processing load at the terminal.

The server improves processing accuracy by combining deterministic language analysis with generative AI inference. The natural language processing program provides structured features such as dependency trees and phrase boundaries that are not easily derived by generic keyword matching. The server uses these features to construct prompt sentences that highlight semantically central phrases, which reduces misinterpretation by the generative AI model. Empirically, this causes fewer off-topic responses and reduces the number of follow-up queries a user must send, leading to fewer total computations over the lifetime of a conversation.

The server also improves system adaptability by dynamically changing the content and format of prompt sentences at runtime, based on classification results and preconfigured rules. Unlike conventional systems that rely on static routing rules or fixed intent taxonomy, the server can modify the way the generative AI model is queried without redeploying code, by altering prompt templates and rule sets stored in a database or configuration repository.

This capability allows fine-grained optimization of system behavior, such as focusing on shorter answers during high-load periods or adding extra verification instructions in safety-critical domains.

From an internal algorithmic perspective, the generative AI model used by the server is configured as a transformer-based neural network including multiple attention heads in each layer. For each token position in the prompt sentence, the neural network computes a context vector by attending to other token positions with learned attention weights. The attention weights are derived from dot products between query vectors and key vectors, scaled and normalized by a softmax function. The network uses residual connections and layer normalization to stabilize training, and a position-wise feed-forward network to project the context vectors into higher-level representations. A language modeling head maps the final hidden states to logits over a vocabulary, and a softmax function converts logits to probability distributions. Loss is computed as the sum of negative log-likelihoods of target tokens, and back-propagation is used to update weights. This architecture enables the generative AI model to capture long-range dependencies in text, which enhances its ability to interpret prompt sentences containing explicit structural cues inserted by the server.

The server takes advantage of this architecture in a non-conventional manner. Instead of sending the raw user inquiry directly to the generative AI model, the server pre-processes the inquiry to enforce a specific structure in the prompt sentence that aligns with how the attention mechanism operates. For example, the server positions the classification label and the key instructions at the beginning of the prompt sentence, which biases attention weights toward these segments. The server also uses punctuation and phrase boundaries to delimit segments in ways that help the transformer architecture identify relevant context. This deliberate structuring of prompt sentences constitutes a specialized rule-based pre-processing layer that is not performed by human operators or by traditional keyword-based systems, and contributes directly to improved computational efficiency and accuracy.

The server is configured to store intermediate representations of inquiries, analysis results, prompt sentences, and responses in a structured format, such as records in a database or objects in an in-memory data store. Each record may include fields such as a unique identifier, raw inquiry text, normalized text, lists of tokens, dependency relations, extracted keywords, classification labels, selected prompt template identifiers, constructed prompt sentence text, generated response text, and formatted response text. The server uses indices on selected fields to quickly retrieve related inquiries and responses, avoiding redundant computations when similar inquiries are received. This data management approach improves throughput and reduces response times in high-traffic environments.

The system can be implemented in various alternative configurations. In one alternative embodiment, the terminal performs part of the natural language processing, such as basic tokenization or language detection, and sends enriched character information including token boundaries or language codes to the server. In another alternative embodiment, a local generative AI model with fewer parameters, such as a compact transformer model, runs on the server side to handle simple inquiries, while a remote large-scale generative AI model is used only for complex or ambiguous cases determined by specific heuristics. This tiered architecture reduces average latency and network usage by reserving remote inference calls for those cases where a large model is expected to provide a significant accuracy gain.

In another embodiment, the server uses different prompt templates and different generative AI models depending on a domain parameter associated with the user account or the service endpoint. For example, the server may use one model tuned for customer support in a commerce domain and another model tuned for technical troubleshooting in an information technology domain. The server stores model selection rules and prompt templates separately for each domain, and selects the appropriate combination at runtime based on metadata, thereby optimizing accuracy without requiring manual model switching by operators.

The system also provides technical improvements in error handling and robustness. The server monitors response lengths, model confidence indicators if available, and structural features of generated text and may re-issue a modified prompt sentence when certain quality thresholds are not met. For example, when the generated response lacks explicit step-by-step instructions in a context where such instructions are required, the server constructs a follow-up prompt sentence that explicitly asks for numbered steps and feeds both the original inquiry and the partially generated response as context to the generative AI model. This iterative strategy is driven by a rule set and executed by the server without human intervention, allowing the computer system to self-correct and produce output that better meets predetermined technical constraints such as maximum length, structural requirements, and clarity measures.

Because the described architecture integrates language analysis, prompt construction, model selection, and output formatting into a coordinated control flow tailored to the capabilities of a transformer-based generative AI model, and because it uses specific data structures, rule sets, and model-aware heuristics, the system achieves technical effects such as faster processing, more accurate routing, reduced network traffic, improved resource utilization, and more predictable behavior of the generative AI model. These improvements arise from the way the server internally processes and structures data for computation and communication, rather than from mere automation of a human mental task, and therefore constitute an enhancement of computer technology itself.

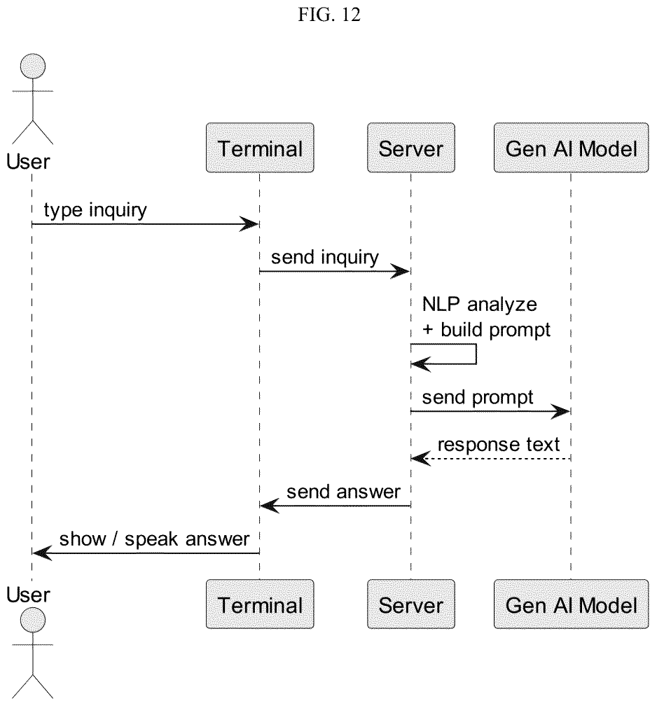

The following describes the processing flow using FIG. 12.

### Step 1

The user operates the terminal to input inquiry information as natural language text.

The terminal displays a text input field on a screen, receives characters from a keyboard or touch panel, and constructs a text string such as “Please tell me how to return a product I recently purchased.” as input.

The terminal converts the text string into a request payload, attaches metadata such as a user identifier and a timestamp, and outputs a structured request object destined for the server over a communication network.

### Step 2

The terminal transmits the structured request object to the server via a communication network.

The terminal encapsulates the request object in a network message, for example a hypertext transfer protocol message, and performs protocol processing including header generation, encoding of the body, and encryption if a secure protocol is used.

The terminal then outputs the encoded network message to a network interface, which sends the message toward the server as a stream of packets.

### Step 3

The server receives the network message and reconstructs the structured request object.

The server uses a network interface and communication stack to accept packets as input, reassembles the packets into a complete protocol message, and decodes headers and the message body.

The server parses the body according to a predetermined format, extracts the inquiry text and metadata, and outputs normalized internal representations of the inquiry text and associated metadata into a memory area.

### Step 4

The server performs text normalization on the inquiry text.

The server receives, as input, the raw inquiry text string from the reconstructed request, converts its character encoding to a unified encoding, and carries out operations such as trimming whitespace, removing control characters, and standardizing line breaks.

The server outputs a cleaned text string as normalized character information, which serves as a stable input to subsequent natural language processing operations.

### Step 5

The server executes morphological analysis and tokenization on the normalized character information.

The server provides the normalized text as input to a natural language processing program, which segments the text into tokens, assigns part-of-speech tags, and identifies word boundaries using a predefined language model.

The server obtains, as output, a sequence of token objects each containing attributes such as surface form, lemma, and part of speech, and stores this sequence in memory as structured token data.

### Step 6

The server performs syntactic analysis on the token sequence.

The server uses the natural language processing program to input the token sequence and apply a syntactic parsing algorithm that computes grammatical relations among tokens, such as subject, object, and modifier relationships.

The server outputs a syntactic structure, such as a dependency tree or graph, where nodes correspond to tokens and edges correspond to syntactic links, and stores this syntactic structure for further analysis.

### Step 7

The server extracts keywords and phrases from the syntactic structure and token sequence.

The server inputs the syntactic structure and token attributes into an extraction module that applies rule-based conditions, such as selecting noun phrases headed by specific parts of speech or verbs associated with objects, and may compute relevance scores using term frequency or positional weights.

The server outputs a list of keywords and phrases that represent salient concepts in the inquiry, and this list is stored as extracted feature data.

### Step 8

The server determines a classification label or type for the inquiry based on the extracted feature data.

The server uses, as input, the list of keywords and phrases, optionally combined with counts of tokens and other features, and feeds numerical feature vectors into a classification algorithm such as a machine learning classifier or a rule engine.

The server computes a classification decision, such as “return request”, “shipping status”, or “product inquiry”, and outputs a classification label representing the inquiry type along with an optional confidence score.

### Step 9

The server selects a prompt template in accordance with the classification label.

The server receives the classification label as input and accesses a template repository in storage, where multiple prompt templates are stored with associated labels.

The server selects a template whose associated label matches the classification label and outputs the selected prompt template as a text pattern that includes placeholder positions for insertion of inquiry text and extracted phrases.

### Step 10

The server constructs a prompt sentence by combining the selected prompt template with the inquiry text and the extracted keywords and phrases.

The server inputs the selected prompt template, the normalized inquiry text, and the list of extracted keywords and phrases, and performs string processing operations to substitute placeholder markers with concrete values.

The server outputs a completed prompt sentence, for example:

A customer says: “Please tell me how to return a product I recently purchased.”

The customer wants to know the return method.

Based on a typical e-commerce return policy, explain the return procedure step by step in clear and concise English. and stores this prompt sentence as the main input for a generative AI model.

### Step 11

The server sends the constructed prompt sentence to a generative AI model.

The server provides, as input, the prompt sentence, a model identifier, and generation parameters such as a maximum token count and a temperature parameter, and encodes these into a request format supported by a generative AI service.

The server transmits this encoded request over a network connection to an inference endpoint and outputs a pending inference state that awaits response data from the generative AI model.

### Step 12

The generative AI model processes the prompt sentence and generates response information, and the server receives the generated response information.

The generative AI model internally performs tokenization, embedding, attention-based context computation, and sequence prediction using trained neural network parameters, and returns a sequence of output tokens to the server as response data.

The server receives, as input, the response data, decodes the tokens into a text string, and outputs raw response information representing a natural language answer to the inquiry.

### Step 13

The server applies output control processing and formatting processing to the raw response information.

The server uses, as input, the raw response text, the classification label, and a predefined rule set that specifies desired properties such as maximum length, structural components, and required detail level.

The server analyzes the response text, splits it into sentences and logical segments, removes or compresses redundant parts, inserts headings or numbered steps if required, and truncates or expands content to meet rule conditions.

The server outputs formatted response information that conforms to a predetermined output format and is optimized for display or audio presentation at the terminal.

### Step 14

The server generates a response message including the formatted response information and transmits the response message to the terminal.

The server inputs the formatted response text and related metadata, encapsulates them into a structured response object, and further encodes this object into a network message conforming to a communication protocol.

The server outputs the encoded network message to a network interface, which sends the message over the communication network toward the terminal.

### Step 15

The terminal receives the response message and reconstructs the formatted response information.

The terminal uses its communication stack to accept incoming packets as input, reassembles the packets into a complete protocol message, and decodes the message headers and body.

The terminal parses the body to extract the formatted response text and associated metadata, and outputs this information to a user interface module for presentation.

### Step 16

The terminal presents the formatted response information to the user in a visually or auditorily perceivable form.

The terminal receives, as input, the formatted response text and uses a graphical user interface to render the text within a display area, applying line breaks, font styles, and layout based on structural components such as headings and lists.

Alternatively or additionally, the terminal inputs the response text into a text-to-speech engine that converts the text to audio waveforms, and outputs the audio through a speaker or headphones, enabling the user to perceive the answer to the original inquiry.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In large-scale information processing environments, user inquiries are increasingly received through various networked interfaces in unstructured natural language. Conventional inquiry routing systems rely on static keyword-based rules, manually maintained decision trees, or fixed classification models. These systems suffer from several technical limitations from a computer-technology standpoint.

First, traditional rule-based engines impose a high computational and maintenance cost on the server. When the number of services, departments, or categories increases, rule sets become large and complex. The processor must evaluate many conditional branches for each inquiry, leading to increased CPU cycles, memory access overhead, and latency. Updating these rules requires manual intervention, which is not dynamically coupled to the actual behavior of the system or to real usage data stored in machine-readable form.

Second, conventional systems do not effectively utilize accumulated historical data stored in storage devices to improve classification logic. Even though the server records large volumes of past inquiries and their final routing results, existing approaches do not provide a technical mechanism on the server side to analyze discrepancies between initial automatic routing and actual corrected assignments, nor to automatically feed this analysis back into the classification logic. As a result, the system cannot self-tune its behavior in a data-driven manner, and computational resources are repeatedly used to execute sub-optimal routing logic.

Third, existing integrations with artificial intelligence technologies are often limited to using a generative AI model as a black-box text generator, without structured control over the prompt sentences and without a feedback loop at the system level. In such designs, the server simply relays raw user text to the generative AI model and accepts an output string, but does not systematically normalize, map, and evaluate that output in relation to internal identification information for response units or personnel. This leads to unstable behavior, difficulty in achieving deterministic mapping to internal entities, and additional processing overhead for error handling on the server.

Fourth, notification handling for routed inquiries is often decoupled from the classification process. In many systems, the server executes independent processes for routing and for notifying terminal devices, which can cause inconsistencies between database state and notifications, duplicate processing, or delays caused by redundant I/O operations. These issues degrade the overall throughput of the server and the responsiveness perceived at the terminal.

Accordingly, there is a need for a computer-implemented technique that improves the functioning of the server itself by: (i) structuring the interaction with a generative AI model through controlled prompt sentences; (ii) automatically mapping AI outputs to internal identifiers of response units or personnel; (iii) recording and analyzing mismatches between AI-based classification and actual assignments; and (iv) automatically updating prompt sentences or classification conditions stored in the system. By tightly integrating these mechanisms with storage devices and notification logic, the system can reduce classification errors, shorten routing latency, and lower the computational and maintenance burden on the server. The technical problem to be solved is, therefore, to provide an improved computer-implemented inquiry routing system that uses a generative AI model in a controlled, feedback-driven manner to optimize internal data processing, classification accuracy, and resource utilization on the server.

The specific processing by the specific processing unit 290 of the data processing device 12 in Example 2 is realized by the following means.

The present invention provides a server comprising a processor and a storage device, the processor being configured to provide a communication interface that receives inquiry information from a user and obtains text data representing the inquiry information; generate, for input to a generative AI model, input information including the text data and a prompt sentence that instructs the generative AI model to identify a corresponding response unit or response personnel for the inquiry information; obtain, from the generative AI model, an analysis result text representing the response unit or the response personnel; perform data processing that classifies the inquiry information by associating the inquiry information with identification information of an internally managed response unit or response personnel based on the analysis result text, including extracting an expression indicating the response unit or the response personnel from the analysis result text and determining the identification information based on a correspondence relationship between the expression and predefined candidates of the response unit or the response personnel; transmit, to a terminal device corresponding to the response unit or the response personnel specified as a result of the classification, notification information including the inquiry information and reference information to an information resource in which the inquiry information is referable; store the inquiry information and the analysis result text in the storage device as accumulated records together with an actual assignment result of the response unit or the response personnel; analyze the accumulated records to evaluate output accuracy of the generative AI model by comparing a result of identifying the response unit or the response personnel by the generative AI model with a corrected response unit or response personnel; and automatically modify, based on a result of the analysis, at least one of a description of candidates of the response unit or the response personnel, an output format specification, and a determination condition included in the prompt sentence, and perform subsequent analysis by the generative AI model using a modified prompt sentence. This enables the server to implement a self-optimizing inquiry routing mechanism in which the interaction with the generative AI model is dynamically tuned based on historical system behavior, thereby improving classification accuracy, reducing processing latency and rule maintenance overhead, and enhancing overall computational efficiency of the computer-implemented routing process.

The term “system” refers to a combination of hardware and software components configured to perform inquiry reception, analysis, classification, storage, and notification processing.

The term “processor” refers to one or more hardware processing units, such as a central processing unit or a processing core, configured to execute instructions that implement the functions described in the claims.

The term “storage device” refers to a non-transitory computer-readable medium, such as a magnetic disk, an optical disk, a solid-state drive, or a semiconductor memory, configured to store programs, inquiry information, analysis results, and accumulated records.

The term “communication interface” refers to a hardware and software combination, such as a network interface controller and communication protocol stack, configured to send and receive data between the server and external devices over a communication network.

The term “inquiry information” refers to data representing a request, question, complaint, or other communication initiated by a user, typically expressed in natural language text.

The term “text data” refers to a sequence of characters or tokens representing at least a part of the inquiry information in a machine-processable textual format.

The term “user” refers to an entity, such as an individual or an organization, that submits inquiry information to the system through a communication interface.

The term “generative AI model” refers to a software-implemented artificial intelligence model, such as a large language model, that generates or analyzes text in response to input text and a prompt sentence.

The term “prompt sentence” refers to text data that instructs the generative AI model regarding a task to be performed, including at least an indication to identify a response unit or response personnel for given inquiry information.

The term “input information” refers to data provided to the generative AI model, including at least text data corresponding to inquiry information and a prompt sentence that specifies a processing instruction.

The term “analysis result text” refers to text data output by the generative AI model in response to the input information, the text data indicating a response unit or response personnel or related information.

The term “response unit” refers to an internal organizational entity, such as a department, group, or team, that is responsible for handling a particular type of inquiry.

The term “response personnel” refers to one or more individuals or roles within a response unit that are responsible for handling a specific inquiry.

The term “identification information” refers to data, such as an identifier, code, or key, that uniquely or distinctively represents a response unit or response personnel within the system.

The term “predefined candidates” refers to a set of response units or response personnel, and associated descriptions or labels, that are stored in advance in the system and used as possible classification targets.

The term “data processing” refers to operations executed by the processor, including analysis, classification, mapping, extraction, comparison, and update of data.

The term “classification” refers to a process of associating inquiry information with one or more response units or response personnel based on the analysis result text and internal rules or mappings.

The term “notification information” refers to data transmitted to a terminal device, including at least a part of the inquiry information and reference information enabling access to a resource in which the inquiry information is stored.

The term “reference information” refers to data, such as a uniform resource locator or an internal identifier, that allows a terminal device or user to access or retrieve stored inquiry information from the system.

The term “terminal device” refers to an external computing device, such as a personal computer, a mobile device, or a workstation, that receives notification information and allows a user to view and handle inquiries.

The term “accumulated records” refers to data stored in the storage device over time, including inquiry information, analysis result texts, and actual assignment results for past inquiries.

The term “actual assignment result” refers to information indicating a response unit or response personnel that actually handled an inquiry, including cases where an initial AI-based classification was corrected.

The term “output accuracy” refers to a measure, determined by the processor, of how correctly the generative AI model identifies a response unit or response personnel relative to the actual assignment result.

The term “correspondence relationship” refers to a mapping rule or table that associates expressions appearing in the analysis result text with identification information of predefined candidates of response units or response personnel.

The term “determination condition” refers to a rule or threshold used by the processor to decide how to interpret the analysis result text and select a specific response unit or response personnel.

The term “output format specification” refers to instructions included in the prompt sentence that define a desired structure, style, or constraints of the text to be generated by the generative AI model.

The term “description of candidates” refers to textual or symbolic representations of response units or response personnel included in the prompt sentence for the purpose of guiding the generative AI model's selection.

The term “subsequent inquiry information” refers to inquiry information received by the system after the prompt sentence or classification conditions have been modified based on prior accumulated records.

The term “self-optimizing inquiry routing mechanism” refers to a system behavior in which the processor automatically adjusts prompt sentences and classification conditions based on historical performance data to improve routing accuracy and efficiency over time.

The server implements the claimed system as a computer-implemented inquiry routing platform executed on one or more information processing devices. The server runs on general-purpose computing hardware, such as a rack-mounted computer equipped with a multi-core central processing unit, a main memory, a non-volatile storage device, and a network interface. The server executes an operating system such as a general-purpose server operating system and middleware including a web application framework, a database management system, and an HTTP client library. The terminal operates as a client device, such as a personal computer, a smartphone, or a tablet, and executes a web browser or a dedicated application. The user operates the terminal to input inquiry information in natural language.

The server provides a communication interface by executing a web application or network service that exposes one or more network endpoints. The server uses a network interface controller and a protocol stack implementing a transport protocol and HTTP to receive inquiry information from the terminal. The terminal sends the inquiry information as structured data, for example, using a JSON payload that includes an inquiry text field, a user identifier field, and metadata fields. The server converts the received JSON string into an internal data structure stored in main memory and writes the inquiry information to a relational or document-oriented database operating as the storage device.

The server generates input information for a generative AI model by combining the text data representing the inquiry information with a prompt sentence. The server stores a prompt template in a configuration data structure in the storage device. The prompt template includes a description of candidate response units or response personnel and instructions regarding output format and determination conditions. For example, the server can use a prompt sentence such as:

“The following is a customer inquiry. Determine which internal department should handle this inquiry. Available departments are: ‘Shopping Department’, ‘Technical Support Department’, ‘Billing Department’, and ‘General Inquiry Department’. Output only the name of the most appropriate department.

Inquiry: ‘Please tell me how to return a product I purchased.’”

The server constructs this prompt sentence by inserting the inquiry text into a predefined template, and the server records the constructed prompt sentence associated with the inquiry identifier in the storage device.

The server communicates with the generative AI model through an application programming interface provided by an external or internal AI platform. The server uses an HTTP client library to send a request containing the prompt sentence and optional control parameters such as a maximum output length, a temperature parameter controlling randomness, and a model identifier specifying a particular generative AI model. The generative AI model is implemented as a neural network-based language model, for example, a transformer architecture comprising multiple layers of self-attention and feed-forward sublayers. The model operates on tokenized representations of text, and the model parameters include weight matrices for attention mechanisms and feed-forward layers.

The server transmits the prompt sentence over a secure transport channel to the AI platform. The AI platform converts the prompt sentence into a sequence of tokens using a tokenizer. The generative AI model then converts each token into an embedding vector. The generative AI model computes attention weights across the sequence using learned weight matrices, applies non-linear activation functions within each layer, and propagates activations through multiple layers. The generative AI model outputs probability distributions over a vocabulary for each token position, and the AI platform generates analysis result text by selecting tokens corresponding to the highest probabilities under constraints specified by the prompt sentence, such as outputting only one department name. The server receives the analysis result text through the HTTP client library and stores the analysis result text associated with the inquiry in the storage device.

The server performs data processing on the analysis result text to convert it into identification information of a response unit or response personnel defined internally. The server uses a correspondence relationship stored in the database, such as a mapping table or dictionary, that associates possible strings output by the generative AI model with unique department identifiers or personnel identifiers. The server normalizes the analysis result text by trimming whitespace, converting character encodings, and optionally applying pattern matching using regular expressions or case-insensitive comparison to align with the stored candidates. The server then looks up the normalized text in the mapping table and obtains an internal identifier. If the text does not exactly match any candidate, the server can apply a fallback algorithm, such as approximate string matching using an edit distance metric or a similarity score computed from vector representations of candidate names, and selects a closest match satisfying a threshold condition.

The server classifies the inquiry information by associating the inquiry record in the database with the selected identifier of the response unit or response personnel. The server updates the inquiry's record to include an assigned department identifier, a classification status, and the raw analysis result text. The server logs this operation for traceability, including a timestamp and the mapping details between the AI output and the internal identifier.

The server then generates notification information to be sent to the terminal associated with the response unit or response personnel. The server constructs a notification payload including the inquiry identifier, a summary of the inquiry text, the assigned department identifier, and reference information such as a resource locator or internal path that allows retrieval of the inquiry content from the server. The server uses a messaging middleware or a push notification service to deliver the notification payload. The terminal receives the notification, decodes the payload, and displays a notification message via its operating system notification framework or user interface layer. The user belonging to the response unit can select the notification and thereby cause the terminal to request detailed information from the server, which the server provides in the form of a markup-based or structured response for display.

The server accumulates records of inquiries, AI outputs, and actual assignment results in the storage device. The server additionally maintains a log of corrections performed by response personnel when an initial AI-based classification is overridden. The server analyzes these accumulated records in order to evaluate the output accuracy of the generative AI model and to improve the classification process. The server executes statistical analysis routines over the database, such as computing the mismatch rate between initially assigned departments based on the analysis result text and the final departments after correction. The server can store confusion data between departments, such as counts of cases where inquiries initially assigned to one department were later reassigned to another department.

The server uses the analysis results to update the prompt sentence or processing conditions in a structured manner. The server determines, for example, that a particular class of inquiries is frequently misrouted between two departments. The server then modifies the prompt template to add more detailed descriptions or constraints. An updated prompt sentence may specify additional examples or clarifications such as:

“The following is a customer inquiry. Determine which internal department should handle this inquiry. Available departments are: ‘Shopping Department (for order placement, returns, and exchanges)’, ‘Technical Support Department (for product malfunctions, installation issues, and connectivity problems)’, ‘Billing Department (for invoices, payments, and refunds)’, and ‘General Inquiry Department (for other questions)’. Output only the exact name of one department from the list above.”

The server stores this updated prompt template in the storage device and uses it for subsequent inquiries. The server thus creates a feedback loop in which the generative AI model's behavior is shaped by prompt sentences that are automatically tuned based on historical system performance and actual assignment results. The server, by adjusting the prompt sentence and mapping logic based on quantitative error analysis, reduces misclassification frequencies, shortens inquiry routing times, and decreases the need for human intervention in correcting routing decisions. This effect leads to a technical improvement in the functioning of the computer system, rather than merely automating a human decision process.

The server can also adjust processing conditions such as decision thresholds in approximate string matching algorithms, or modify the set of candidate department names and identifiers stored in the mapping table. When the server observes systematic patterns in analysis result text that do not match existing candidates, the server can add intermediate mapping rules. For example, if the generative AI model frequently outputs variant phrasing such as “Online Shopping Support” instead of “Shopping Department”, the server adds a rule mapping “Online Shopping Support” to the identifier of the “Shopping Department”. This rule-based refinement operates in conjunction with the generative AI model and reduces the need for re-training the model while still improving the computer's routing function.

The server uses the generative AI model not only as a generic text generator but as a controlled classification element integrated into a specific data flow. By defining explicit output format specifications and candidate descriptions in the prompt sentence, and by processing the output with deterministic mapping logic and structured error analysis, the server achieves more stable and predictable behavior than a naive black-box integration. The server reduces computational waste because misclassifications that require multiple re-queries and manual corrections are decreased. The server also reduces network traffic and CPU consumption by lowering the number of repeated calls to the generative AI model and by preventing unnecessary transactions caused by incorrect routing.

The generative AI model itself can be trained or fine-tuned using a supervised learning procedure. The training data includes historical pairs of inquiry texts and correct department labels. The model uses a loss function, such as cross-entropy, calculated between predicted token sequences and target label tokens representing department names. During training, an optimizer adjusts the model's weight parameters by applying gradient descent, backpropagating the error through the transformer layers. The model can be fine-tuned on domain-specific data stored in the server's storage device or a dedicated training data store. The server can export misclassified examples and their corrected labels to the training pipeline, thereby assisting in iterative improvement of the generative AI model's parameters.

The server, in some embodiments, can implement a local inference engine that runs the generative AI model on-premises using specialized hardware such as graphics processing units or tensor-processing units. The server then directly controls the neural network inference process, including tokenization, embedding lookup, attention computation, and output decoding. The server can adjust inference parameters in real time depending on load conditions, such as reducing the maximum output length or narrowing the candidate space in the prompt sentence with a view to minimize latency during peak usage.

The terminal contributes to the technical effect by efficiently rendering notifications and inquiry details in a manner that reduces server load. The terminal can cache frequently used resources such as interface assets and partial templates so that the server primarily transmits compact data structures representing inquiry content and classification results. The terminal uses local rendering logic to display and update user interfaces, which reduces redundant data transfer and improves responsiveness. The server, by leveraging the terminal's render capabilities, can focus its processing resources on analysis, classification, and optimization tasks.

The user interacts with this system by submitting inquiries and by optionally correcting misclassified routing decisions through the terminal interface. When the user belonging to a response unit changes the assigned department of an inquiry, the terminal sends structured update data back to the server. The server logs this correction and immediately reflects it in the accumulated records used for analysis. This human-in-the-loop mechanism is realized as formalized input to the computer's training and tuning pipeline and not as an ad hoc manual action without system impact.

In some embodiments, the server can implement multiple generative AI models or model variants and can select between them according to system conditions or inquiry characteristics. For example, the server can choose a smaller, faster model for short, routine inquiries and a larger, more accurate model for complex or ambiguous inquiries. The server stores performance metrics associated with each model, including average latency and classification accuracy, and can dynamically adapt model selection to balance computational cost and accuracy. This model selection logic further improves computer resource utilization and overall system throughput.

In other embodiments, the server can implement additional pre-processing and post-processing modules. The server can apply a feature extraction algorithm to the inquiry text, such as detecting specific entities or phrases using pattern-based recognizers, and can augment the prompt sentence with these structured features to guide the generative AI model.

The server can also add post-processing steps that apply deterministic rules for certain high-priority patterns. For instance, the server can directly route inquiries containing specific critical error codes to a technical support unit without invoking the generative AI model, which reduces latency and computation for these special cases.

The described configurations, when implemented as a whole, improve the technical field of computer-based inquiry routing by producing a system that self-optimizes its prompt sentence, mapping rules, and classification conditions based on data-driven feedback from actual operation. The server thereby enhances the accuracy and speed of automated routing while reducing computational overhead and maintenance complexity. The system's design focuses on controlling and integrating a generative AI model within concrete data structures, storage mechanisms, and communication interfaces, rather than performing abstract mental steps or generic data processing. As a result, the invention provides a technical improvement in computer functioning and network-based information processing.

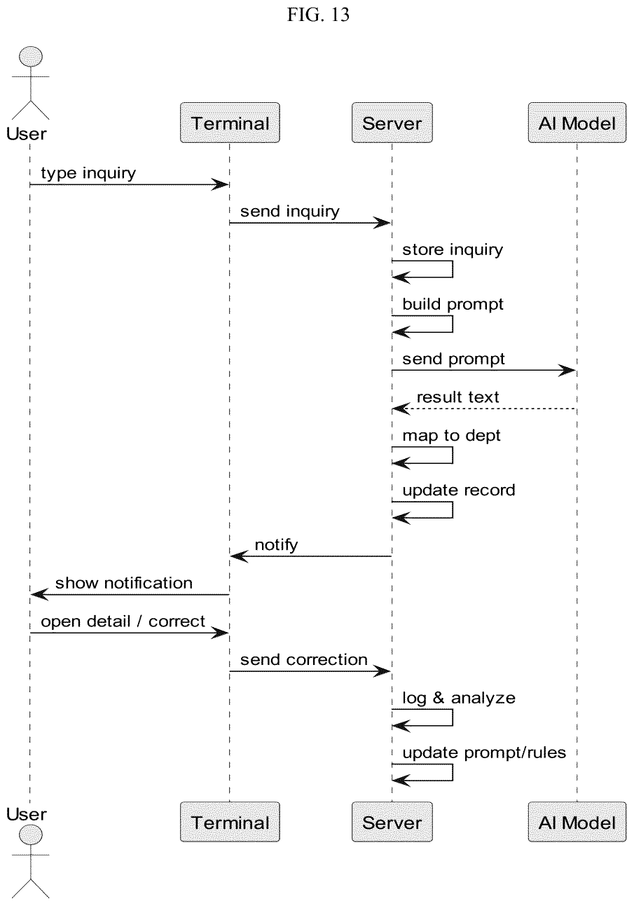

The following describes the processing flow using FIG. 13.

### Step 1

The user inputs inquiry information on the terminal.

The terminal displays an input screen provided by the server, including a text box and a send button.

The user types natural language text such as “Please tell me how to return a product I purchased.” into the text box.

The terminal, as input, receives keystroke events from the user and constructs an internal string representing the inquiry text.

The terminal, as output, generates a structured data object (for example, including a user identifier, a timestamp, and the inquiry text) in memory to be sent to the server.

### Step 2

The terminal sends the inquiry information to the server.

The terminal, as input, uses the structured data object created in Step 1.

The terminal serializes the data object into a JSON string, encapsulates it in an HTTP request body, and attaches HTTP headers including content type and authentication information.

The terminal performs a network transmission over a communication interface using a transport protocol to the server's endpoint.

The terminal, as output, transmits the HTTP request and waits for an acknowledgment or response from the server.

### Step 3

The server receives and stores the inquiry information.

The server, as input, receives the HTTP request containing the JSON string from the terminal through its communication interface.

The server parses the HTTP headers and body, deserializes the JSON string into an internal data structure in main memory, and validates fields such as the presence of inquiry text and user identifier.

The server performs data processing by writing a new record to a database table, assigning a unique inquiry identifier, and setting an initial status such as “pending_classification.”

The server, as output, stores the inquiry information persistently and returns a simple acknowledgment to the terminal, including the generated inquiry identifier.

### Step 4

The server constructs a prompt sentence for the generative AI model.

The server, as input, retrieves the stored inquiry text and a prompt template from the database or configuration storage.

The server performs string operations such as concatenation and template substitution to combine the prompt template with the inquiry text.

The server may normalize the inquiry text (for example, by trimming whitespace or converting character encoding) before insertion into the template.

The server, as output, generates a complete prompt sentence in text form, for example: “The following is a customer inquiry. Determine which internal department should handle this inquiry. Available departments are: ‘Shopping Department’, ‘Technical Support Department’, ‘Billing Department’, and ‘General Inquiry Department’. Output only the name of the most appropriate department.

Inquiry: ‘Please tell me how to return a product I purchased.’”

### Step 5

The server sends the prompt sentence and related parameters to the generative AI model.

The server, as input, uses the complete prompt sentence created in Step 4 and model control parameters such as model name, maximum output length, and temperature.

The server constructs a JSON payload containing the prompt sentence and parameters, and uses an HTTP client library to form an HTTPS request to an AI platform endpoint.

The server encrypts the request using a transport security protocol and includes an authorization token in the headers.

The server, as output, transmits the request to the generative AI model endpoint and places a pending state marker for the corresponding inquiry in its internal tracking structure.

### Step 6

The generative AI model generates analysis result text.

The generative AI model, as input, receives the prompt sentence and parameters from the server.

The generative AI model tokenizes the prompt sentence into tokens, converts tokens into numerical embeddings, and performs matrix multiplications and attention computations layer by layer in a transformer architecture.

The generative AI model computes probability distributions over vocabulary tokens at each generation step and selects tokens that form the name of a response unit, such as “Shopping Department,” according to output format constraints encoded in the prompt sentence.

The generative AI model, as output, returns analysis result text to the server through a JSON response containing the generated string.

### Step 7

The server parses the analysis result text and maps it to internal identification information.

The server, as input, receives the JSON response from the generative AI model, including the generated text field.

The server extracts the text field, normalizes it by trimming spaces and standardizing case, and then compares the normalized text against a mapping table of predefined candidates stored in the database or in memory.

The server performs data processing by executing a lookup operation; if a direct match is found, the server obtains the corresponding internal department identifier. If no direct match exists, the server applies a fallback algorithm such as approximate string matching or similarity scoring to determine the most likely identifier.

The server, as output, produces an internal identifier representing the response unit or response personnel, and associates this identifier with the inquiry record.

### Step 8

The server updates the classification of the inquiry in the database.

The server, as input, uses the inquiry identifier and the internal identifier of the response unit or response personnel derived in Step 7.

The server executes an update operation on the database, setting fields such as assigned department identifier, classification timestamp, and classification status.

The server may also store the raw analysis result text for audit and later analysis.

The server, as output, generates an updated inquiry record in persistent storage reflecting the classification result.

### Step 9

The server generates notification information for the terminal.

The server, as input, uses the updated inquiry record, including the inquiry text and assigned department identifier.

The server constructs a notification payload that includes a summary of the inquiry text, the inquiry identifier, the department identifier, and reference information such as a uniform resource locator for a detail page.

The server performs data processing to format this payload into a compact structure suitable for a push service or messaging channel and may add priority flags or timestamps.

The server, as output, produces a notification data object ready to be transmitted to one or more terminals associated with the response unit.

### Step 10

The server transmits the notification to the terminal associated with the response unit.

The server, as input, uses the notification data object from Step 9 and routing information that associates the response unit identifier with one or more target terminals.

The server selects a delivery mechanism, such as a push notification service, a WebSocket channel, or a messaging queue, and sends the notification payload through the corresponding network path.

The server may update a delivery log in the database to record that a notification was dispatched for the inquiry.

The server, as output, delivers the notification payload to the terminal and provides a log entry for subsequent monitoring.

### Step 11

The terminal receives and displays the notification.

The terminal, as input, receives the notification payload from the server or from an intermediary notification service.

The terminal parses the payload to extract fields such as the inquiry summary, inquiry identifier, and reference information.

The terminal uses its operating system's notification interface to construct a visual or audible alert, including text such as “New inquiry for Shopping Department: ‘Please tell me how to return a product I purchased.’” and a selectable element linked to the reference information.

The terminal, as output, presents the notification on the display and maintains an actionable item that, when selected by the user, triggers a request for detailed inquiry information.

### Step 12

The user accesses and optionally corrects the classification result.

The user, as input, selects the notification or navigates to an inquiry list on the terminal.

The terminal sends a request to the server for the inquiry details using the inquiry identifier; the server responds with structured data including the assigned department and inquiry text.

The terminal renders the detail view; the user reads the assigned department and, if needed, selects a different department from a list or confirms the current assignment.

The terminal, as output, transmits any correction or confirmation back to the server as structured update data for logging and analysis.

### Step 13

The server records corrections and evaluates the output accuracy of the generative AI model.

The server, as input, receives correction data from the terminal indicating a revised department identifier or a confirmation.

The server writes this correction to a dedicated table in the database that links the inquiry identifier, the original AI-based assignment, and the final assignment.

The server performs data aggregation operations such as counting mismatches and computing ratios per department or per time period.

The server, as output, produces statistical metrics stored in the database, representing the generative AI model's output accuracy and patterns of misclassification.

### Step 14

The server updates prompt sentences and processing conditions based on accumulated records.

The server, as input, accesses the statistical metrics and accumulated records, including inquiry texts, analysis result texts, and corrected assignments.

The server applies an analysis algorithm that detects recurring misclassification patterns, such as frequent confusion between particular departments, and determines changes to the prompt template, candidate descriptions, or determination thresholds.

The server modifies the prompt template stored in configuration data, for example by adding more detailed descriptions of department responsibilities or by tightening output format requirements, and updates mapping tables to include additional variant expressions.

The server, as output, produces revised prompt sentences and updated mapping or threshold parameters that will be used in subsequent executions of Steps 4 through 7, thereby enabling continuous improvement of routing performance.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional inquiry management systems typically rely on static keyword matching, rigid rule engines, or manually maintained routing tables to assign incoming user inquiries to responsible organizational units. Such systems often treat all inquiries as structurally similar text messages and do not effectively model higher-level intent or user emotion. As a result, these systems tend to exhibit several technical shortcomings at the computing-system level.

First, conventional systems perform routing logic largely in application code without leveraging advanced natural language understanding. Because the routing is based on simple string matching or predefined patterns, the processor must repeatedly scan full text fields and apply large, sparse rule sets, which leads to inefficient use of memory and processor resources as the number and diversity of inquiries increase. This causes increased latency in classifying and routing inquiries, higher CPU load, and scalability bottlenecks when the volume of inquiries suddenly grows.

Second, conventional systems generally store inquiry data as unstructured text, without systematically transforming it into machine-interpretable structured attributes such as intent categories, extracted entities, or emotion labels. This lack of structured intermediate representations prevents downstream subsystems, such as ticket management modules and notification modules, from optimizing scheduling, queue ordering, and network communication. In particular, the absence of emotion-based attributes makes it difficult for the system to adjust processing priority at the infrastructure level, resulting in suboptimal allocation of processing resources and network bandwidth among concurrently processed inquiries.

Third, existing architectures typically invoke external natural language models or sentiment analyzers in an ad hoc manner, for example, by issuing independent calls from separate components. This fragmented invocation pattern leads to redundant network traffic, uncoordinated caching, and repeated processing of the same text by different components, thereby increasing end-to-end latency and consuming unnecessary computing and communication resources. Furthermore, because intent and emotion are not jointly modeled and associated with each specific inquiry in a unified data structure, the system cannot deterministically and efficiently compute routing and prioritization decisions.

Accordingly, there is a need for a technical architecture in which a processor systematically transforms raw natural language inquiry text into structured intent, routing, and emotion attributes by coordinating a generative AI model and an emotion analysis model via explicitly generated prompt sentences. Such an architecture should reduce redundant processing, provide consistent intermediate representations, and enable more efficient and deterministic routing and prioritization in the server, thereby improving overall throughput, response time, and resource utilization of the computerized inquiry handling system.

The specific processing by the specific processing unit 290 of the data processing device 12 in Application Example 2 is realized by the following means.

The present invention provides a server comprising a processor configured to provide an information input/output interface that receives inquiry information expressed as natural language data from a user, generate a prompt sentence including the inquiry information, the prompt sentence instructing a generative AI model to identify an intent of the inquiry and a responsible organizational unit, cause the generative AI model to execute analysis processing based on the prompt sentence to obtain analysis results including at least classification information indicating an inquiry category, execute preprocessing on the inquiry information before inputting the inquiry information to the generative AI model by using a natural language processing library to extract phrase information and identifier information from the inquiry information and storing an association between the extracted phrase information and identifier information and at least one of the prompt sentence and the classification information, input the inquiry information to an emotion analysis model, cause the emotion analysis model to identify emotion information indicating an emotional state of the user included in the inquiry information and store an association between the emotion information and the classification information, automatically sort the inquiry information to a corresponding organizational unit based on the classification information and the emotion information, set a processing priority for the inquiry information based on the emotion information, register the inquiry information with the processing priority in a business processing system, and transmit notification information to a terminal used by a responsible organizational unit based on the inquiry information and the processing priority registered in the business processing system so that the inquiry information is displayable on the terminal. This enables the server to transform unstructured natural language inquiries into unified structured attributes for intent, routing, and emotion within a single coordinated processing pipeline, thereby reducing redundant text processing, improving the determinism and efficiency of routing and prioritization operations, lowering computational and communication overhead, and enhancing overall system throughput and response latency in computer-implemented inquiry handling.

The term “system” refers to an arrangement including at least one information processing device and one or more storage devices that cooperate to execute the functions described in the claims.

The term “server” refers to an information processing apparatus configured to receive, process, store, and transmit digital data over one or more communication networks.

The term “processor” refers to one or more hardware processing units, such as a central processing unit or a graphics processing unit, configured to execute instructions to perform the operations described in the claims.

The term “user” refers to a human operator or an external entity that provides inquiry information to the system.

The term “terminal” refers to an information processing device, such as a client computer or a portable communication device, used by the user or by a staff member in a responsible organizational unit to send or receive information to or from the server.

The term “information input/output interface” refers to a hardware and software interface that enables the server to receive and transmit digital data, including inquiry information, over a communication network or via a local interface.

The term “inquiry information” refers to data including natural language text that represents a question, request, complaint, or report provided by a user to the system.

The term “natural language data” refers to character data that expresses content in a human language, such as a sentence or phrase written in a natural language.

The term “generative AI model” refers to a machine learning model that performs natural language generation or understanding based on a probabilistic or neural network architecture and that produces output text or structured information in response to input data and a prompt sentence.

The term “prompt sentence” refers to a text sequence that includes instruction content and optionally inquiry information and that is supplied to the generative AI model to specify a type of analysis or output format to be generated by the generative AI model.

The term “analysis processing” refers to computation executed by the generative AI model in response to the prompt sentence and the inquiry information to generate classification information, intent information, or other structured information.

The term “classification information” refers to information indicating a category, label, or type assigned to the inquiry information, such as an inquiry category or an intent class.

The term “inquiry category” refers to a classification label that represents a type of the inquiry, such as a delivery issue category, a billing category, or a support category.

The term “responsible organizational unit” refers to a group or functional unit in an organization, such as a department or team, that is designated to handle the inquiry information according to the classification information.

The term “phrase information” refers to words, phrases, or token sequences that are extracted from the inquiry information by natural language processing.

The term “identifier information” refers to structured data elements extracted from the inquiry information, such as an identifier, code, number, or name that can be used to uniquely or semi-uniquely identify an order, product, account, or other object.

The term “natural language processing library” refers to a software component configured to perform operations such as tokenization, part-of-speech tagging, entity extraction, and syntactic analysis on natural language data.

The term “emotion analysis model” refers to a machine learning model or software component configured to analyze natural language data and output emotion information indicating an emotional state associated with the data.

The term “emotion information” refers to information representing an emotional state of the user inferred from the inquiry information, such as anger, frustration, confusion, neutrality, or satisfaction.

The term “emotional state” refers to a condition representing an affective status of the user, determined from linguistic or contextual cues contained in the inquiry information.

The term “preprocessing” refers to processing executed on the inquiry information prior to supplying the inquiry information to the generative AI model, including at least one of tokenization, phrase extraction, or identifier extraction.

The term “automatically sort” refers to causing the server to assign the inquiry information to a responsible organizational unit without manual selection by a human operator, based on classification information, emotion information, or rule sets.

The term “processing priority” refers to a value or level that indicates a relative urgency or importance for processing the inquiry information compared with other inquiry information.

The term “business processing system” refers to an information processing system used to manage, store, and track business tasks associated with inquiries, such as a ticket management system, workflow management system, or customer support system.

The term “notification information” refers to data transmitted from the server to a terminal of a responsible organizational unit to indicate the presence, classification, and processing priority of inquiry information.

The term “specified response format” refers to a predetermined structure or pattern of output text that the generative AI model is instructed, via the prompt sentence, to follow when generating its output.

The term “rule set” refers to a collection of predetermined conditions and corresponding actions that are used by the processor to determine the responsible organizational unit, the processing priority, a registration class, or a notification destination for the inquiry information.

The term “registration class” refers to a type or category of registration operation performed in the business processing system, such as a queue type, ticket type, or workflow type assigned to the inquiry information.

The term “notification destination” refers to an address, endpoint, queue, or account in the business processing system or communication infrastructure to which the notification information is transmitted.

In one embodiment, a server cooperates with one or more terminals operated by users and staff members to implement the claimed system. The server includes at least one central processing unit (CPU), at least one memory device storing executable instructions and data structures, at least one non-volatile storage device, and at least one network interface configured to communicate over a packet-switched network such as the Internet. The terminal includes a processing unit, a display device, an input device, and a network interface, and executes a web browser or an application program that communicates with the server by using a communication protocol such as HTTPS.

The server executes a program that implements an inquiry handling platform. The program is stored in the memory as multiple software modules, including an interface module, a preprocessing module, a generative AI interface module, an emotion analysis interface module, a routing module, a priority determination module, a ticket integration module, and a notification module. The server uses these modules to transform raw natural language inquiry information into structured attributes including classification information and emotion information, to register such attributes in a business processing system, and to control notification to terminals used by responsible organizational units.

The server provides an information input/output interface by executing the interface module. The interface module exposes a network endpoint, for example an HTTP application programming interface, that accepts requests from terminals. The terminal renders a graphical user interface, such as a web page or a mobile application screen, that includes an input field in which a user enters inquiry information expressed as natural language. The terminal transmits the text entered by the user together with metadata, such as a user identifier, a time stamp, and a device identifier, to the server by using a structured data format such as a character string payload in a request body.

The server receives the inquiry information at the interface module and stores the inquiry information in a data structure in memory. In one embodiment, the server stores the inquiry information in an inquiry record that includes fields such as an inquiry identifier, a user identifier, a raw text field, a classification information field, an emotion information field, and a processing priority field. The server further stores the inquiry record in a relational database management system so that the inquiry record is persistently maintained.

The server executes the preprocessing module to transform the raw text of the inquiry information into intermediate natural language representations. The server uses a natural language processing library, such as a tokenization and part-of-speech tagging library, to divide the text into tokens, assign a part-of-speech tag to each token, and detect phrase boundaries. The server further uses a named-entity recognition algorithm to extract identifier information, such as order numbers, customer identifiers, product names, date expressions, and location names. The server stores extracted phrase information and identifier information in association with the inquiry record. For example, the server stores the phrase information and identifier information in separate tables linked by a foreign key to the inquiry identifier, enabling efficient indexed access to the linguistic features of the inquiry.

The server generates a prompt sentence for a generative AI model by executing the generative AI interface module. The server constructs the prompt sentence by combining a fixed instruction template with the actual inquiry text and, in some embodiments, with selected phrase information and identifier information. In one specific example, the server generates a prompt sentence in the following form:

“Analyze the following inquiry and identify the appropriate department and user intent. Respond only with a short category name. Inquiry: ‘The product I ordered has not arrived. What is going on?’”

In another example, the server generates a prompt sentence that jointly requests category and emotion:

“Analyze the following inquiry. (1) Identify the main category. (2) Identify whether the user is angry, frustrated, confused, or neutral. Respond in the format: ‘category=. . . , emotion=. . . ’. Inquiry: ‘I've contacted you three times about my missing order and I'm really angry now.’”

The server transmits the prompt sentence to a generative AI model deployed on the same machine as the server or on a separate computing resource connected over the network. In one embodiment, the generative AI model is implemented as a deep neural network having a transformer architecture with multiple encoder-decoder attention layers. The model receives a sequence of tokens corresponding to the prompt sentence. The model internally represents each token as an embedding vector and applies multi-head self-attention operations across layers to compute context-dependent representations. The model has been trained in advance on a large corpus of natural language data by minimizing a loss function such as cross-entropy between predicted next tokens and actual tokens, and optionally fine-tuned on a data set of labeled inquiries and categories.

The server configures hyperparameters of the generative AI model call, such as a maximum output length, a sampling temperature, and a probability threshold, in order to obtain deterministic and compact output suitable for routing. The generative AI model outputs a sequence of tokens that, when decoded, yields a short text such as “delivery problem”, “return procedure”, or “billing issue”, or a structured text such as “category=delivery problem, emotion=anger”. The server parses the output, normalizes the string, and maps the output to internal classification information, for example, by mapping “delivery problem” to a predefined category code.

The server executes the emotion analysis interface module in parallel or in sequence with the generative AI interface module. In one embodiment, the server uses a separate emotion analysis model with a neural network classifier that receives a vector representation of the inquiry text and outputs a probability distribution over emotion classes, such as anger, frustration, confusion, neutrality, and satisfaction. The neural network may be implemented by using a transformer architecture or a recurrent neural network with attention, trained on a supervised emotion-labeled corpus to minimize a categorical cross-entropy loss function. The server computes emotion information by selecting the emotion class with the highest probability above a threshold and storing both the discrete class and the raw probability scores in association with the inquiry record.

In another embodiment, the server uses the generative AI model itself to output both classification information and emotion information by generating a prompt sentence that requires a response in a specified format containing both attributes. In this embodiment, the server simplifies the number of remote calls and reduces network latency, because a single model invocation yields both intent and emotion. The server parses the structured response string according to the specified format, extracts the category field and the emotion field, and stores these as classification information and emotion information, respectively.

The server executes the routing module to determine a responsible organizational unit for the inquiry. The routing module uses the classification information, the phrase information, and the identifier information as inputs to a rule set stored as a table or a configuration file. Each rule describes conditions based on category codes, presence of specific phrases, or specific identifier patterns, and an action specifying an organizational unit identifier. For example, a rule may specify that a category code corresponding to delivery issues combined with the presence of a shipping-related phrase routes the inquiry to a logistics organizational unit. The server evaluates the rules in a predetermined sequence or with a priority scheme, and selects a single responsible organizational unit. This rule-based mapping, implemented as table lookups and conditional branching in the processor, allows the server to perform routing decisions without re-computing deep linguistic analysis, thereby reducing processing time per inquiry.

The server executes the priority determination module to compute a processing priority level. The server uses the emotion information as a primary input and, in some embodiments, additional attributes such as user membership level or historical complaint frequency. The priority determination module executes a deterministic function, such as a lookup table or a decision tree, that maps different emotion classes to priority levels. For example, the server may assign a highest priority level to emotion classes of anger or strong dissatisfaction, a medium priority to confusion, and a normal priority to neutrality. The server writes the computed priority value into the processing priority field of the inquiry record and updates associated indices in the database so that queries ordering by priority are efficiently supported.

The server executes the ticket integration module to propagate the inquiry record to a business processing system, such as a ticket management system. The server constructs a ticket payload that includes at least the inquiry identifier, the user identifier, the classification information, the emotion information, the processing priority, and the responsible organizational unit identifier. The server transmits the payload to the business processing system over a network interface by using an application programming interface offered by the business processing system. The business processing system stores the ticket and returns a ticket identifier, which the server stores in the inquiry record as a foreign key. In some embodiments, the ticket integration module normalizes fields so that they match field names and types defined by the business processing system, ensuring that sorting by priority and filtering by category can be executed within the business processing system without redundant transformation.

The server executes the notification module to generate and transmit notification information to terminals used by staff members of the responsible organizational unit. The notification information includes the inquiry text, the classification information, the emotion information, and the processing priority. The server may use a push-style protocol such as webhooks or a polling-style interface in which the terminal periodically requests updated notifications. The server ensures that high-priority inquiries are delivered with lower latency by, for example, placing such notifications at the head of an outgoing queue or by marking them for priority delivery in a messaging service.

The terminal used by a staff member connects to the business processing system or directly to the server and retrieves a list of inquiries assigned to the responsible organizational unit. The terminal displays the inquiries on a screen in an order determined by the processing priority, allowing the staff member to visually identify those inquiries associated with negative emotions. The terminal may also display contextual attributes, such as the extracted identifier information, to facilitate immediate access to related records in back-end systems. By using the structured attributes computed by the server, the terminal can reduce the number of manual steps required for the staff member to access necessary information.

The server achieves an improvement in computer technology relative to conventional systems for multiple reasons. First, by generating structured classification information and emotion information using a generative AI model and an emotion analysis model, and by associating these attributes with each inquiry record, the server enables downstream modules to operate on compact, indexed fields instead of reprocessing entire unstructured text. This reduces the amount of data scanned by the processor and improves cache utilization, leading to lower average processing time and improved throughput when many inquiries are processed concurrently.

Second, by using a prompt sentence that specifies a constrained output format and task description, the server guides the generative AI model to produce concise and deterministic outputs. This stands in contrast to generic natural language generation, which can be verbose and inconsistent. The constrained output reduces parsing complexity and error rates when mapping model outputs to internal category codes, thereby reducing misrouting and lowering the need for reprocessing or manual correction. The server thus improves both classification accuracy and routing efficiency at the system level.

Third, by integrating preprocessing, generative AI analysis, emotion analysis, routing, and ticket integration into a single coordinated pipeline in the server, the system avoids redundant invocations of external models and repeated storage of intermediate unstructured data. The server controls the order and combination of operations and caches intermediate results in memory structures designed for reuse across modules. This reduces network traffic between components, reduces computation performed by external services, and decreases end-to-end latency from inquiry reception to ticket registration.

Fourth, the server implements a rule set and priority determination function that operate on structured attributes produced by machine learning models, not on raw text. This allows non-trivial routing policies and scheduling strategies to be implemented as simple table lookups and comparisons that can be efficiently executed by the processor. The use of emotion information as a direct input to scheduling decisions is not merely an automation of human judgment; it changes the underlying computational behavior of the system by enabling the processor to reallocate CPU cycles, memory resources, and outbound network bandwidth in favor of high-priority inquiries. For example, the server may allocate more worker threads to queues containing high-priority inquiries and may commit such inquiries to persistent storage with higher frequency to reduce data loss risk.

Fifth, the generative AI model and emotion analysis model in the server have been trained by using machine learning techniques, such as supervised or semi-supervised learning, with specific loss functions and optimization algorithms. During training, the server or a training environment loads large amounts of historical inquiry data, converts the data into tokens, and repeatedly updates the model parameters, such as weights of attention layers and biases of output layers, by executing gradient-based optimization algorithms. These learning processes enable the models to capture subtle patterns in language that are not easily encoded by static rules. As a result, the server is able to correctly classify inquiries even when they contain diverse expressions or previously unseen phrasing, thereby improving classification robustness and reducing the need for manual rule updates.

In another embodiment, the server deploys the generative AI model on specialized hardware, such as a graphics processing unit or a tensor processing unit. The model executes matrix multiplications, non-linear activation functions, and normalization operations in parallel across many units, and the server manages batching of multiple inquiries into a single inference request to maximize hardware utilization. This hardware-aware scheduling by the server further reduces per-inquiry processing time and improves scalability, which is a technical improvement over conventional sequential CPU-bound rule evaluation.

In yet another embodiment, the server supports multiple generative AI models and emotion analysis models with different architectures or parameter sizes. The server may select a smaller model for short or low-impact inquiries and a larger model for complex or high-impact inquiries. This selection is performed automatically by the server based on metadata such as message length or preliminary keyword analysis. By doing so, the server optimizes the trade-off between computational cost and classification quality, further improving resource utilization.

In a further embodiment, the server employs data structures that specifically support the association of phrase information, identifier information, classification information, and emotion information with each inquiry. For example, the server maintains an inverted index that maps category codes and emotion classes to sets of inquiry identifiers, enabling rapid retrieval of all pending high-priority inquiries in a given category. This index is updated incrementally when new inquiries are processed or when classification information is refined. Such indexing is a technical measure that directly impacts retrieval performance and is not tied to any particular business rule.

In another variation, the server uses a deduplication algorithm that compares identifier information and phrase information across incoming inquiries to detect duplicates or related inquiries. When a duplicate is detected, the server updates an existing inquiry record rather than creating a new record. This reduces storage redundancy and also consolidates model processing by reusing existing classification information and emotion information. The deduplication may use hash functions or locality-sensitive hashing on token sequences, representing a technical optimization in data management.

The terminal, by cooperating with the server, benefits from these technical improvements without needing to implement complex language understanding locally. The terminal transmits compact requests and receives already prioritized and structured data, which allows the terminal to render efficient user interfaces and to minimize its own CPU and memory usage.

Through these embodiments, the server, the terminal, and the user cooperate in a manner that goes beyond mere automation of human routing decisions. The server transforms unstructured natural language data into structured attributes by using specific model architectures, prompt sentence designs, preprocessing algorithms, and routing rules, and exploits these attributes to improve processing speed, classification precision, data storage efficiency, and communication efficiency within the computing infrastructure.

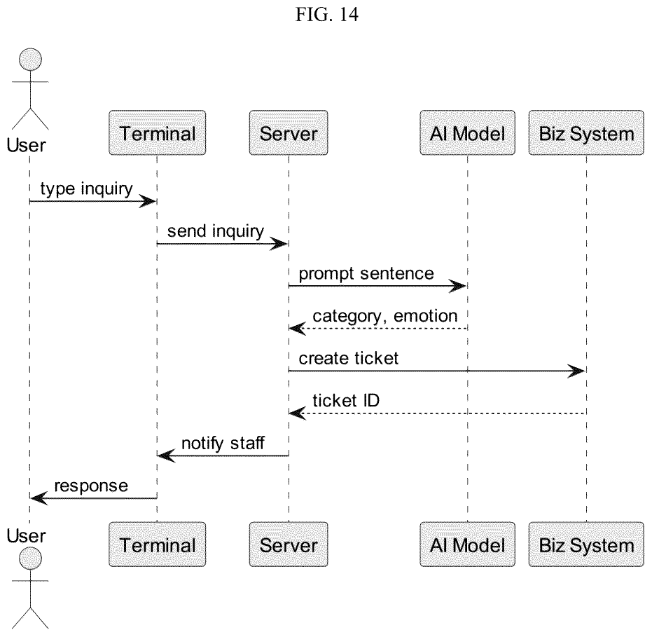

The following describes the processing flow using FIG. 14.

### Step 1

The user operates the terminal and inputs inquiry information as natural language text.

The terminal displays an input field on a screen and receives a character string such as “The product I ordered has not arrived.” from the user.

Input: keystrokes from the user.

Output: a text string stored in the terminal's working memory.

The terminal converts the keystrokes into a Unicode text buffer, attaches metadata such as a user identifier and a time stamp, and prepares a structured request payload.

### Step 2

The terminal transmits the inquiry information to the server.

The terminal packages the text string and metadata into a request message, for example an HTTP POST request over HTTPS, and sends it to a predefined server endpoint.

Input: the text string and metadata in the terminal's memory.

Output: a network packet stream carrying the request to the server.

The terminal performs protocol processing, including header generation, payload encoding, and encryption, to transform the internal data structure into a form compatible with the network interface.

### Step 3

The server receives and stores the raw inquiry information.

The server accepts the incoming request via a network interface, parses the protocol headers, and extracts the text string and metadata.

Input: the network packet stream containing the request.

Output: an inquiry record stored in server memory and, optionally, a database.

The server allocates an inquiry identifier, creates a data structure containing the raw text, the user identifier, and the time stamp, and inserts this structure into a persistent storage system.

### Step 4

The server performs natural language preprocessing on the inquiry information.

The server invokes a natural language processing library to tokenize the text, assign part-of-speech tags, and detect phrase boundaries and named entities.

Input: the raw text field of the inquiry record.

Output: phrase information and identifier information associated with the inquiry record.

The server computes token indices, extracts noun phrases and verb phrases, and identifies patterns corresponding to order numbers or account identifiers, then stores these extracted items in separate tables linked to the inquiry identifier.

### Step 5

The server generates a prompt sentence for a generative AI model.

The server combines a fixed instruction template with the raw text and, optionally, with selected phrase information or identifier information to form a single text sequence.

Input: the raw text, phrase information, and system configuration parameters.

Output: a prompt sentence string.

The server concatenates instruction text, delimiters, and the user's text, producing, for example:

“Analyze the following inquiry and identify the appropriate department and user intent. Respond only with a short category name. Inquiry: ‘The product I ordered has not arrived. What is going on?’”

The server stores this prompt sentence in memory, linked to the inquiry identifier.

### Step 6

The server encodes the prompt sentence and calls the generative AI model.

The server converts the prompt sentence into token identifiers using a tokenizer consistent with the model's vocabulary, then sends the token sequence to the generative AI model as input.

Input: the prompt sentence string.

Output: a tokenized representation transmitted to the generative AI model and, subsequently, a model output sequence.

The server sets model parameters such as maximum output length and sampling temperature, issues an inference request, and waits for the model to return an output token sequence.

### Step 7

The server decodes the model output and derives classification information.

The server converts the output token sequence back into a text string and normalizes this string.

Input: the model output token sequence.

Output: classification information stored as a category code or label.

The server trims whitespace and special characters, interprets the text such as “delivery problem” or “billing issue,” and maps the text to an internal category code using a lookup table; the mapped code is then written into the classification information field of the inquiry record.

### Step 8

The server performs emotion analysis on the inquiry information.

The server transmits either the raw text or a vector representation of the text to an emotion analysis model that outputs emotion scores.

Input: the raw text of the inquiry and, optionally, token or embedding vectors.

Output: emotion information indicating an emotional state of the user.

The server receives a numeric score vector corresponding to predefined emotion classes, selects the class with the highest score above a threshold (e.g., anger, frustration, neutral), and stores both the selected class and the underlying scores in the emotion information field associated with the inquiry.

### Step 9

The server determines a responsible organizational unit based on structured attributes.

The server evaluates a rule set that takes the classification information, phrase information, and identifier information as inputs.

Input: the category code, extracted phrases, and extracted identifiers.

Output: an organizational unit identifier stored in the inquiry record.

The server matches the category code against routing rules, optionally checks for specific keywords such as “delivery” or “refund,” and selects an organizational unit, such as logistics or support, by reading the corresponding identifier from a configuration table.

### Step 10

The server computes a processing priority for the inquiry.

The server applies a priority determination function to the emotion information and optional additional attributes, such as user type.

Input: the emotion class, emotion scores, and metadata such as membership level.

Output: a priority level code written into the processing priority field.

The server compares the emotion class to a mapping table, assigns a higher priority to negative emotions such as anger, and combines this result with user metadata to compute a final numeric or ordinal priority value.

### Step 11

The server registers the inquiry in a business processing system.

The server constructs a payload containing the inquiry identifier, user identifier, classification information, emotion information, processing priority, and responsible organizational unit.

Input: the inquiry record enriched with structured attributes.

Output: a registration result including a ticket identifier from the business processing system.

The server invokes an application programming interface of the business processing system, transmits the payload, receives a ticket identifier, and stores this identifier in association with the inquiry record.

### Step 12

The server generates and sends notification information to a terminal used by the responsible organizational unit.

The server composes a notification message including the inquiry text, the category label, the emotion class, and the priority level, formatted for display.

Input: the updated inquiry record and ticket identifier.

Output: a notification message delivered to the terminal over a communication channel.

The server places the message into an outgoing queue, orders messages by priority, and transmits them via email, messaging, or a push interface to the terminal of the responsible organizational unit.

### Step 13

The terminal used by a staff member receives and displays the notification information.

The terminal accepts the incoming notification or retrieves pending notifications from the server or business processing system.

Input: the notification message containing the structured attributes.

Output: a visual representation of the inquiry on a display device.

The terminal parses the received data, updates an on-screen list sorted by the priority level, and renders key fields such as summary text, category, emotion, and urgency indicator, enabling the staff member to select and respond to high-priority inquiries first.

### Step 14

The staff member responds through the terminal, and the server updates the inquiry state.

The terminal provides an input area in which the staff member types a response, then sends the response text and the related ticket identifier back to the server or directly to the business processing system.

Input: the staff member's response text and an associated identifier.

Output: an updated ticket or inquiry state in the server and business processing system.

The server records the response in persistent storage, updates the status field of the inquiry record (for example, from “open” to “in progress” or “answered”), and may trigger additional notifications to the user via the terminal, closing the loop of the inquiry handling flow.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

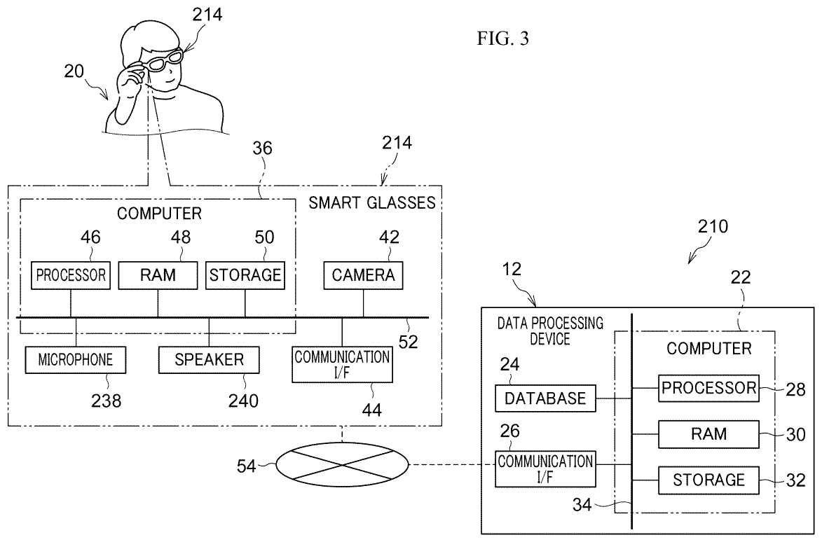

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

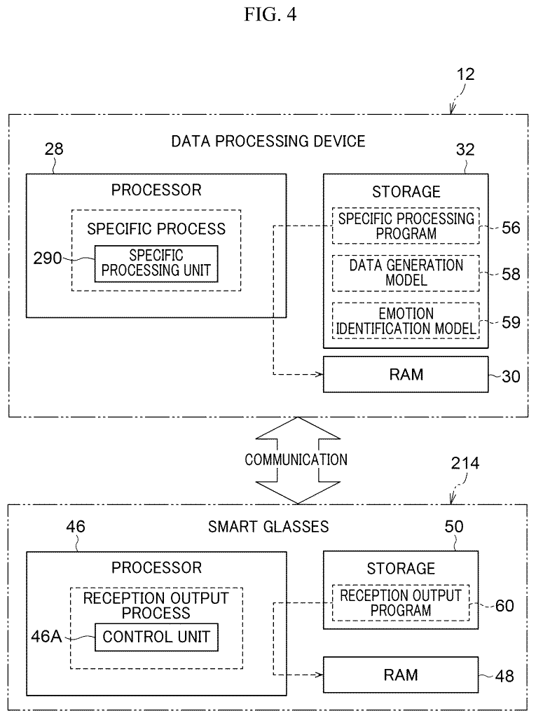

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

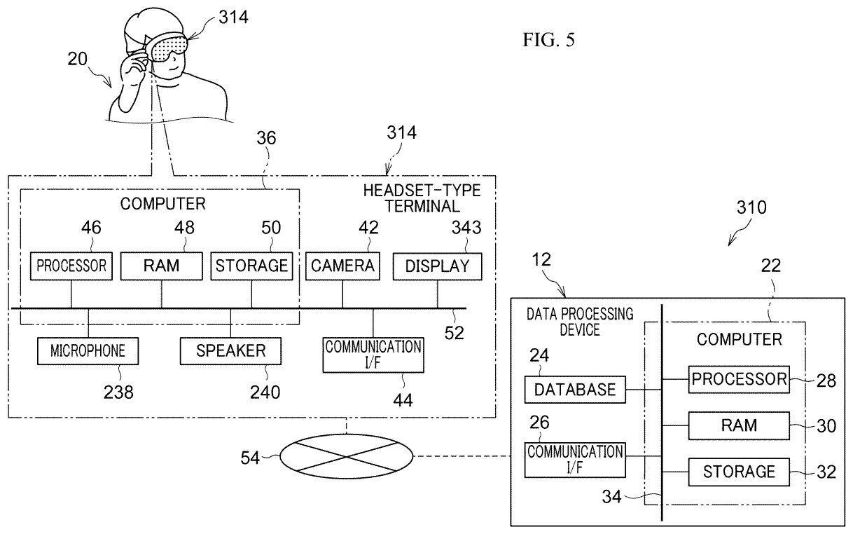

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

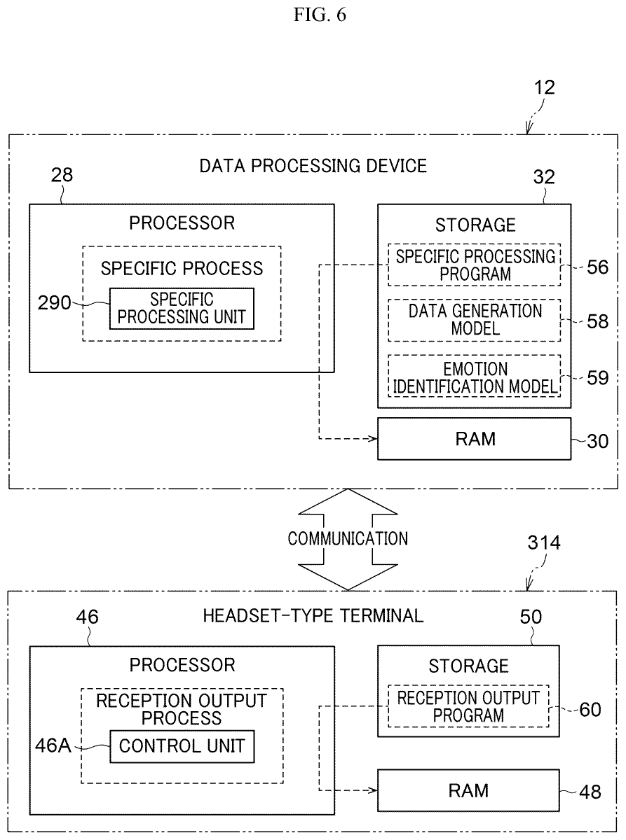

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

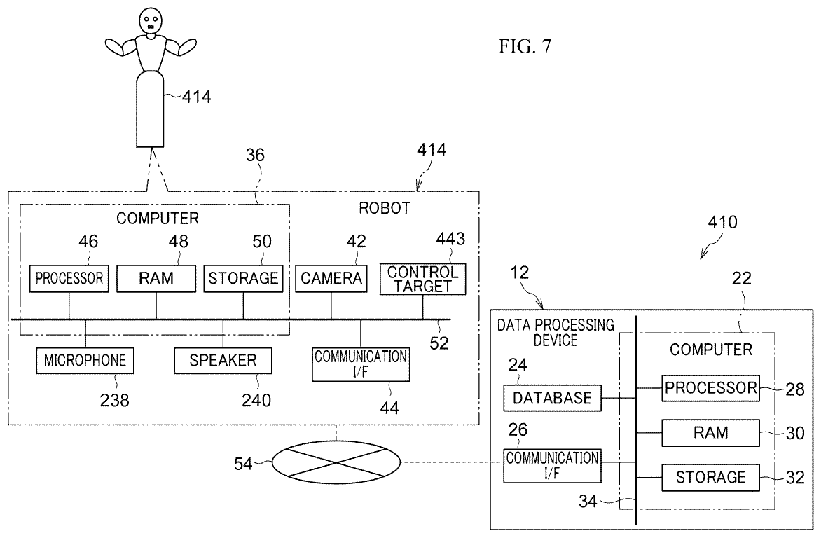

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

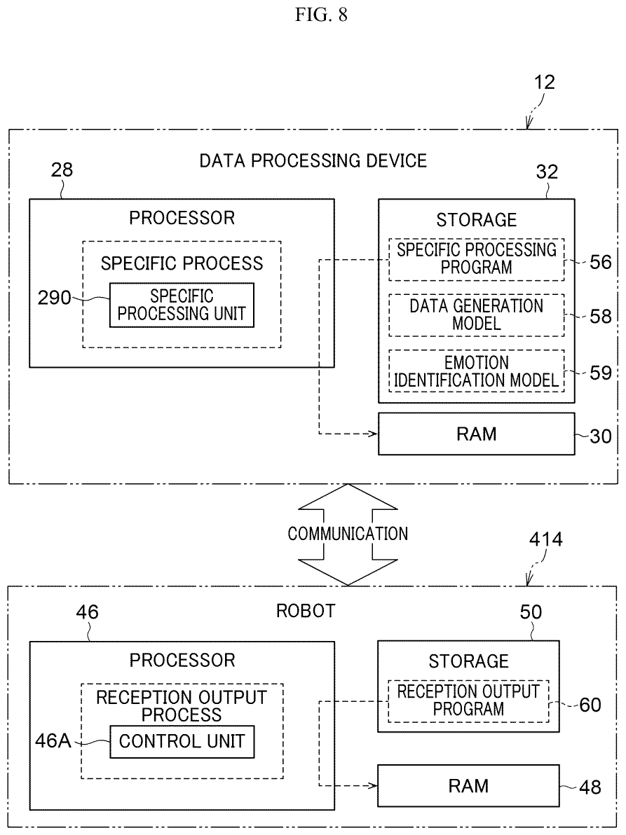

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai. com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

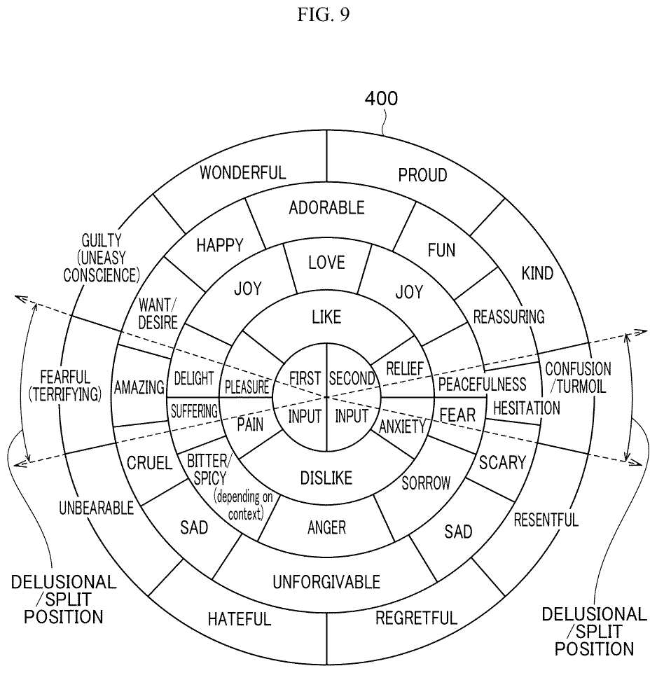

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

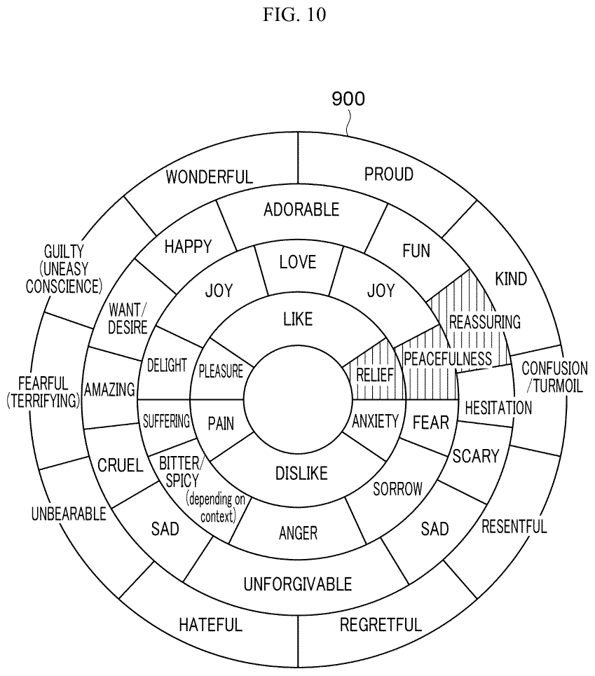

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
provide, via a communication network, an interface for receiving inquiry information from a user and to record the inquiry information together with associated attribute information, generate analysis request information including analysis target information comprising the inquiry information and a prompt sentence that instructs a generative information processing model to extract important features from the analysis target information and to identify a user intent and a related service category, and transmit the analysis request information to the generative information processing model,
receive, from the generative information processing model, response information as analysis result information generated on the basis of the prompt sentence, the response information including important feature information and service category information relating to the inquiry information, and classify the inquiry information into a predetermined business function on the basis of the service category information and previously stored correspondence information,
activate a business processing function corresponding to a classification result, generate user response information on the basis of processing result information obtained from the business processing function, and transmit the user response information to a terminal device via the interface, and
store, in a storage device, the inquiry information, the analysis result information, and the classification result in association with one another.

### Supplementary 2

The system according to supplementary 1,
wherein the processor is configured to
cause the prompt sentence to include content that instructs the generative information processing model to extract a plurality of keywords from the inquiry information, to determine intent information for the inquiry information on the basis of the plurality of keywords, to select, from among a plurality of types of service category candidates, a service category having highest relevance to the inquiry information, and to output the intent information and the selected service category in a predetermined structured data format.

### Supplementary 3

The system according to supplementary 1,
wherein the processor is configured to
select the business processing function corresponding to the classification result on the basis of the service category information and a predefined rule set that defines a correspondence between service categories and internal processing functions, the predefined rule set including conditions for switching the business processing function in accordance with at least one of an inquiry channel type, user attribute information, and an occurrence time of the inquiry.

### Application Example 1

### Supplementary 1

A system comprising a processor,
wherein the processor is configured to
receive inquiry information transmitted from a user terminal via a communication network and acquire the inquiry information as character information,
execute morphological analysis and syntactic analysis on the acquired character information by using a natural language processing program as a language analysis software implemented by information processing, and extract keywords and phrases from the character information, construct a prompt sentence to be input to a generative artificial intelligence model on the basis of the extracted keywords and phrases and a type of the inquiry, and transmit the prompt sentence to the generative artificial intelligence model,
acquire response information generated by the generative artificial intelligence model in response to the prompt sentence and perform formatting processing on the response information into a predetermined output format, and
transmit the formatted response information toward the user terminal so that the user terminal outputs the formatted response information in a form that is visually or auditorily presentable.

### Supplementary 2

The system according to supplementary 1,
wherein the processor is configured to
use, as the natural language processing program, language analysis software based on a statistical method or a machine learning method, estimate an intention or a classification of the inquiry on the basis of an analysis result obtained by the language analysis software, and dynamically change content or a format of the prompt sentence to be input to the generative artificial intelligence model in accordance with an estimation result.

### Supplementary 3

The system according to supplementary 1,
wherein the processor is configured to
execute output control processing on the response information acquired from the generative artificial intelligence model on the basis of a classification of the inquiry or a predefined rule set so as to adjust at least one of a detail level of explanation, a length of text, structural components, and reference destination information, and transmit the adjusted response information to the user terminal.

### Example 2

### Supplementary 1

A system comprising a processor,
wherein the processor is configured to
provide a communication interface that receives inquiry information input by a user and obtains text data representing the inquiry information,
generate, for input to a generative AI model, input information including the text data and a prompt sentence that instructs the generative AI model to identify a corresponding response unit or response personnel for the inquiry information,
obtain, from the generative AI model, an analysis result text representing the response unit or the response personnel, and perform data processing that classifies the inquiry information by associating the inquiry information with identification information of an internally managed response unit or response personnel based on the analysis result text,
transmit, to a terminal device corresponding to the response unit or the response personnel specified as a result of the classification, notification information including the inquiry information and reference information to an information resource in which the inquiry information is referable, and
store the inquiry information and the analysis result text in a storage device for accumulation, and update a content of the prompt sentence or a processing condition for the classification based on accumulated records stored in the storage device.

### Supplementary 2

The system according to supplementary 1,
wherein the processor is configured to
extract, from the analysis result text obtained from the generative AI model, an expression indicating the response unit or the response personnel, determine the identification information based on a correspondence relationship between the expression and predefined candidates of the response unit or the response personnel, and evaluate output accuracy of the generative AI model by comparing a result of identifying the response unit or the response personnel by the generative AI model with a corrected response unit or response personnel provided by the user or the response personnel.

### Supplementary 3

The system according to supplementary 1,
wherein the processor is configured to
analyze past inquiry information stored in the storage device, the analysis result text output by the generative AI model for the past inquiry information, and an actual assignment result of the response unit or the response personnel, automatically modify, based on a result of the analysis, at least one of a description of candidates of the response unit or the response personnel, an output format specification, and a determination condition included in the prompt sentence, and perform analysis by the generative AI model for subsequent inquiry information using the modified prompt sentence.

### Application Example 2

### Supplementary 1

A system comprising a processor,
wherein the processor is configured to
provide an information input/output interface that receives inquiry information expressed as natural language data from a user, generate a prompt sentence including the inquiry information, the prompt sentence instructing a generative AI model to identify an intent of the inquiry and a responsible organizational unit, and cause the generative AI model to execute analysis processing based on the prompt sentence to obtain analysis results including at least classification information indicating an inquiry category,
execute preprocessing on the inquiry information before inputting the inquiry information to the generative AI model, the preprocessing comprising using a natural language processing library to extract phrase information and identifier information from the inquiry information and storing an association between the extracted phrase information and identifier information and at least one of the prompt sentence and the classification information, input the inquiry information to an emotion analysis model, cause the emotion analysis model to identify emotion information indicating an emotional state of the user included in the inquiry information, and store an association between the emotion information and the classification information,
automatically sort the inquiry information to a corresponding organizational unit based on the classification information and the emotion information, set a processing priority for the inquiry information based on the emotion information, and register the inquiry information with the processing priority in a business processing system, and
transmit notification information to a terminal used by a responsible organizational unit based on the inquiry information and the processing priority registered in the business processing system so that the inquiry information is displayable on the terminal.

### Supplementary 2

The system according to supplementary 1,
wherein the processor is configured to
generate the prompt sentence as a sentence including instruction content that causes the generative AI model to output not only the inquiry category but also a type of the emotional state of the user in a specified response format, and obtain an output result of the generative AI model based on the prompt sentence as the classification information and the emotion information.

### Supplementary 3

The system according to supplementary 1,
wherein the processor is configured to
receive the classification information, the phrase information, the identifier information, and the emotion information as inputs, determine the responsible organizational unit and the processing priority for the inquiry information based on a predefined rule set, and control a registration class and a notification destination in the business processing system according to a determination result.

What is claimed is:

1. A system comprising:
circuitry configured to:
receive, via a communication interface coupled to a packet-switched network, input text data from a terminal device;
construct a prompt data structure that includes the input text data and an instruction sequence directing a generative neural network model to extract feature data from the input text data and to output classification data in a structured format;
transmit the prompt data structure to the generative neural network model and receive, from the generative neural network model, response data including the classification data;
determine, on the basis of the classification data and correspondence data stored in a storage device, a processing function identifier that maps the classification data to an internal processing function; and
transmit, to the terminal device via the packet-switched network, output data generated by executing the internal processing function identified by the processing function identifier.

2. The system according to claim 1, wherein the circuitry executes, prior to constructing the prompt data structure, a natural language processing operation on the input text data, the natural language processing operation including at least one of morphological analysis that segments the input text data into token units and assigns grammatical attribute labels, and syntactic analysis that determines dependency relations among the token units.

3. The system according to claim 2, wherein the circuitry extracts, from results of the natural language processing operation, keyword data and phrase data on the basis of grammatical attribute labels and dependency relations, computes a relevance score for each of the keyword data and the phrase data, and selects keyword data and phrase data exceeding a relevance threshold for incorporation into the prompt data structure.

4. The system according to claim 3, wherein the circuitry determines, on the basis of the keyword data and the phrase data, a classification label for the input text data by applying a classification model that receives feature vectors derived from the keyword data and the phrase data and outputs a label from a set of predetermined classification labels, and selects a prompt template from a plurality of stored prompt templates on the basis of the classification label.

5. The system according to claim 4, wherein the classification label indicates an inquiry category associated with a communication network service, and the circuitry constructs the prompt data structure by inserting the input text data, the keyword data, and the classification label into the selected prompt template.

6. The system according to claim 1, wherein the generative neural network model comprises a transformer architecture including a token embedding layer, a positional encoding mechanism, a plurality of self-attention layers, and feedforward sublayers, and the instruction sequence within the prompt data structure specifies a constrained output format requiring the response data to include at least a feature field and a category field.

7. The system according to claim 6, wherein the circuitry parses the response data by identifying field delimiters specified in the constrained output format, extracts the feature field as feature data comprising keyword strings, and extracts the category field as the classification data, and validates the classification data against a set of permissible category values stored in the storage device.

8. The system according to claim 7, wherein the circuitry, when the classification data does not match any permissible category value, applies an approximate matching algorithm that computes a similarity score between the classification data and each permissible category value and selects the permissible category value having a highest similarity score exceeding a predetermined threshold.

9. The system according to claim 1, wherein the circuitry further inputs the input text data to an emotion classification model and obtains emotion data indicating an emotional state associated with the input text data, and determines a processing priority value on the basis of the emotion data.

10. The system according to claim 9, wherein the emotion classification model comprises a neural network that receives a vector representation of the input text data and outputs a probability distribution over a plurality of emotion classes, and the circuitry selects an emotion class having a highest probability exceeding a confidence threshold as the emotional state.

11. The system according to claim 10, wherein the circuitry assigns a highest processing priority value when the emotional state indicates at least one of anger and frustration, and transmits notification data including the input text data, the classification data, and the processing priority value to a second terminal device associated with an organizational unit identified by the processing function identifier.

12. The system according to claim 1, wherein the circuitry stores, in the storage device, the input text data, the classification data, and an assignment result in association with one another as accumulated record data, and analyzes the accumulated record data to compute an accuracy metric by comparing the classification data with corrected assignment data.

13. The system according to claim 12, wherein the circuitry, on the basis of the accuracy metric, automatically modifies at least one of a candidate description, an output format specification, and a determination condition included in the instruction sequence of the prompt data structure, and applies the modified prompt data structure to subsequent input text data received via the communication interface.

14. The system according to claim 13, wherein the circuitry detects a misclassification pattern between two or more category values in the accumulated record data and modifies the candidate description to include additional distinguishing criteria for the two or more category values, thereby reducing a misclassification rate for subsequent input text data.

15. The system according to claim 1, wherein the circuitry generates the output data by activating the internal processing function, which retrieves domain-specific data from the storage device on the basis of the processing function identifier and the input text data, and applies a template engine to merge the domain-specific data into a response format.

16. The system according to claim 15, wherein the circuitry performs formatting processing on the output data on the basis of the classification data and a formatting rule set stored in the storage device, the formatting processing adjusting at least one of a detail level, a text length, and structural components of the output data.

17. The system according to claim 1, wherein the circuitry applies a secondary rule set to the classification data and attribute data associated with the input text data, the attribute data including at least one of a channel type indicator, a source network identifier, and a temporal indicator, and overrides the processing function identifier when the secondary rule set indicates a different internal processing function.

18. A system comprising:
circuitry configured to:
receive, via a communication interface coupled to a packet-switched network, input text data from a terminal device, and store the input text data together with attribute data in a storage device;
execute a natural language processing operation on the input text data including morphological analysis and syntactic analysis to extract keyword data and phrase data, and compute relevance scores for the keyword data and the phrase data;
select a prompt template from a plurality of stored prompt templates on the basis of a classification label determined from the keyword data and the phrase data, and construct a prompt data structure by inserting the input text data, the keyword data, and an instruction sequence specifying a constrained output format into the selected prompt template;
transmit the prompt data structure to a generative neural network model comprising a transformer architecture with a token embedding layer, a positional encoding mechanism, a plurality of self-attention layers, and feedforward sublayers, and receive response data including classification data and feature data in the constrained output format;
input the input text data to an emotion classification model and obtain emotion data indicating an emotional state, and determine a processing priority value on the basis of the emotion data;
determine, on the basis of the classification data and correspondence data stored in the storage device, a processing function identifier, and transmit notification data including the input text data, the classification data, and the processing priority value to a second terminal device associated with an organizational unit identified by the processing function identifier;
store the input text data, the classification data, the emotion data, and an assignment result as accumulated record data in the storage device, and analyze the accumulated record data to compute an accuracy metric; and
automatically modify, on the basis of the accuracy metric, at least one of a candidate description, an output format specification, and a determination condition included in the instruction sequence of the prompt data structure for application to subsequent input text data.

19. The system according to claim 18, wherein the circuitry detects a misclassification pattern between two or more category values in the accumulated record data and modifies the candidate description to include additional distinguishing criteria, and assigns the highest processing priority value when the emotional state indicates at least one of anger and frustration.

20. A method performed by circuitry of a server coupled to a packet-switched network via a communication interface, the method comprising:
receiving, via the communication interface, input text data from a terminal device;
constructing a prompt data structure that includes the input text data and an instruction sequence directing a generative neural network model to extract feature data from the input text data and to output classification data in a structured format;
transmitting the prompt data structure to the generative neural network model and receiving, from the generative neural network model, response data including the classification data;
determining, on the basis of the classification data and correspondence data stored in a storage device, a processing function identifier that maps the classification data to an internal processing function; and
transmitting, to the terminal device via the packet-switched network, output data generated by executing the internal processing function identified by the processing function identifier.
